(19) United States
(12) Patent Application Publication
(10) Pub. No.: US 2024/0181280 A1
(43) Pub. Date: Jun. 6, 2024

(54) SYSTEMS AND METHODS FOR ADSORPTION CAPACITY ESTIMATION

(71) Applicant: 3M INNOVATIVE PROPERTIES COMPANY, St. Paul, MN (US)

(72) Inventors: Frank Ding, Waxhaw, NC (US); Darin K. Thompson, Huntersville, MN (US); Daniel B. Taylor, White Bear Lake, MN (US); Steven T. Awiszus, Woodbury, MN (US); Wenli Wang, Woodbury, MN (US); Kevin A. Frankel, Woodbury, MN (US); Dong Fu, Woodbury, MN (US); Richard C. Webb, St. Paul, MN (US); Lisa M. Croll, Ontario (CA)

(21) Appl. No.: 18/527,428

(22) Filed: Dec. 4, 2023

Related U.S. Application Data
(60) Provisional application No. 63/386,052, filed on Dec. 5, 2022.

(51) Int. Cl. A62B 18/08; A62B 9/00

(52) U.S. Cl. CPC A62B 18/088; A62B 9/006; A62B 18/02

(57) ABSTRACT

A filter predicted capacity estimation system is presented that includes a parameter retriever that retrieves parameter information for an atmosphere around the filter. The system includes a parameter trend retriever that retrieves historical parameter indications from a database. The system also includes a real time capacity estimator that, based on the parameter information retrieved, and solves a set of controlling equations to generate an estimated capacity. The controlling equations are a set of mass and energy balance equations. The system also includes a parameter projection generator that, based on the historic parameter indications, generates a future parameter trend for the atmosphere and filter use. The system also includes a predicted capacity estimator that, based on the adsorption estimate, and based on the future parameter trend, generates a predicted capacity estimate. The system also includes a signal generator that generates a signal if either the estimated capacity or the predicted capacity estimate is above a threshold.

### BACKGROUND

Maintaining the safety and health of workers is a major concern across many industries. Various rules and regulations have been developed to aid in addressing this concern. Such rules provide sets of requirements to ensure proper administration of personnel health and safety procedures. To help in maintaining worker safety and health, some individuals may be required to don, wear, carry, or otherwise use a personal protective equipment (PPE) article, if the individuals enter or remain in work environments that have hazardous or potentially hazardous conditions. In environments where the atmosphere contains toxic chemicals, workers need to wear PPE with a filtering system to make the air safe to breath.

Consistent with evolving rules and regulations related to safety, safety is an important concern in any workplace requiring the use of PPE. Companies or businesses employing workers wearing articles of PPE also want to ensure that workers are complying with relevant laws, regulations and company policies related to proper use and maintenance of PPE.

A variety of air purification systems have been developed to protect people from hazardous air contaminants. Among these air purification systems are a wide range of air purifying respirators that are designed to filter out and/or sorb contaminants present in the air. Upon use of the respirator, the contaminants become captured and absorbed or adsorbed by the respirator. Eventually, the ability of the respirator to remove the hazardous contaminants from air begins to diminish.

During extended exposure to an environment containing hazardous air contaminants, such as, continuous or repeated worker exposure to such environments, techniques are necessary to determine the useful service life of a respirator. One technique that has been developed is based upon the time in service for a respirator. In this technique, respirators or the air purifying filters are replaced after a certain period of time in service. However, this technique does not take into account variations in contaminant level or flow rates through the respirator and therefore may result in the respirator or filter elements being changed too early (which is wasteful) or too late (which may present a danger to the user).

### SUMMARY

A filter predicted capacity estimation system is presented that includes a parameter retriever that retrieves parameter information for an atmosphere around the filter. The system includes a parameter trend retriever that retrieves historical parameter indications from a database. The system also includes a real time capacity estimator that, based on the parameter information retrieved, and solves a set of controlling equations to generate an estimated capacity. The controlling equations are a set of mass and energy balance equations. The system also includes a parameter projection generator that, based on the historic parameter indications, generates a future parameter trend for the atmosphere and filter use. The system also includes a predicted capacity estimator that, based on the adsorption estimate, and based on the future parameter trend, generates a predicted capacity estimate. The system also includes a signal generator that generates a signal if either the estimated capacity or the predicted capacity estimate is above a threshold.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIGS. 1A-1B illustrate a PPE device in which embodiments herein may be useful.

FIG. 2 illustrates a worksite in which embodiments of the present invention may be useful.

FIGS. 3A-3B illustrates operation of a parameter prediction system in accordance with embodiments herein.

FIG. 4 illustrates a method of indicating a predicted capacity estimations for a device in accordance with embodiments herein.

FIG. 5 illustrates a capacity estimation system in accordance with embodiments herein.

FIG. 6 illustrates a mobile simulation device in one embodiment of the present invention.

FIG. 7 illustrates a capacity estimation system architecture.

FIGS. 8-10 illustrate example devices that can be used in embodiments herein.

### DETAILED DESCRIPTION

Manually monitoring PPE use in a given workplace can be cumbersome and time consuming for supervisors or safety compliance officers. Improved methods and systems for monitoring safety compliance, PPE maintenance, and providing safety-related contextual information in a work environment requiring the use of PPE are needed.

As described herein, in some environments, the air around a worker in a workplace may be contaminated with toxic chemicals or hazardous particles that may be dangerous to the workforce. It is important for workers, as well as safety compliance officers, to know when a filter responsible for protecting the worker must be replaced. Currently users either change out their filter based on estimates using generic or supplier provided tools or, when estimations are not available sometimes, change out based on taste or smell. This brings its own challenges in that many containments have low odor and taste thresholds, and user may lose olfactory sensitivity over time. There are many different factors contributing to determining when a given filter cartridge has reached capacity, many of which affect how quickly or slowly a given toxic material will be removed and accumulated in the cartridge. Some factors include: temperature, relative humidity and air pressure of the site atmosphere, a flow rate (a function of breathing rate in a negative pressure respirator and the tidal volume of each breath which varies based on gender, weight and work rate, or a flow rate supplied by a positive pressure respirator such as a Powered Air Purifying Respirator (PAPR), and or concentrations of toxic materials in the air. Respirators may operate either under negative pressure or positive pressure. PAPRs are operated in a positive-pressure continuous flow mode providing filtered ambient air. Alternatively, Negative-Pressure respirators operate by the wearer drawing air into the facepiece via the negative pressure created by the user's inhalation. As described herein, the term “flow rate” is used to refer, in positive pressure embodiments, the blower flow rate and, in negative pressure embodiments, a user's inhalation rate.

Additionally, each of hundreds of toxic chemicals or a combination of few may be present in a particular environment, all with their own varying sorption behavior, each of which may cause a filter to reach or near capacity threshold that requires replacement. Because the sorption rate for a filter can vary significantly based on so many parameters, it is difficult for manufacturers to provide a precise or accurate service life. Wood et al. describes equations for a simulation that can be completed for determining adsorption rate of a sorbent bed. (Estimating Service Lives of Organic Vapor Cartridges, Wood et al., American Industrial Hygiene Association Journal, J.55(1): 11-15 (1994); Estimating Service Lives of Organic Vapor Cartridges IIL A Single Vapor at All Humidities, Wood. Gerry O., Journal of Occupational and Environmental Hygiene, J1: 472-492; Estimating Service Lives of Organic Vapor Cartridges III: Multiple Vapors at All Humidities; Wood et al., Journal of Occupational and Environmental Hygiene. J4: 363-374). Currently many developed capacity estimation software programs are based on the Wood equations and may only have accuracy of around +/−50%. Employers want to efficiently use filter cartridges to reduce costs, but not at the risk of chemical breakthrough that could harm workers. An improved way to estimate a remaining capacity based on actual and varying use conditions for a filter is desired.

The term “filter” and similar words such as “filter cartridge”, “filter canister”, “respirator filter”, “filter element”, and “Gas & Vapor filter” may all be used herein to refer to an article with sorbent substance packed or filled in a defined shape that is used to remove gas and vapor contaminants in air stream that passes through. The “filter cartridge” and “filter canister” may contain certain volume of sorbents as suggested in NIOSH “Guide to Industrial Respiratory Protection” by Dept of Health and Human Services v. 1987. but are not limited by those specified volume ranges. All above mentioned terms are considered used interchangeable hereinafter. All can be of different shapes and sizes.

The term “combination filter” refer to a “filter” or “filter cartridge” or “filter canister” or “respirator filter”, “filter element” or “gas and vapor (G&V) filter” that has particulate removal filter(s) incorporated for intended use of removing both gas and vapor contaminants and particulate contaminants (in air and/or gas).

The term “particulate filter” refers to a filter that only removes particulates (in air and/or gas).

The term “sorb” and similar words such as “sorbing”, “sorbed”, and “sorption” refer to the addition of a first substance (e.g. a gas such as hydrogen sulfide, sulfur dioxide, ammonia or vapor such as octane, toluene, benzene, cyclohexane, to a second substance (e.g. a porous sorbent such as activated carbon or porous polymeric material or both) by adsorbing, absorbing, or both. The first substance is sometimes referred to as a “sorbate”.

As used herein, the term “concentration” refers to the concentration of a single contaminant that a sorbent is designed to adsorb or absorb from ambient air. Systems and methods herein describe the simpler scenario of a single sorbent filtering a single contaminant. However, it is expressly contemplated that some sorbents may remove more than one contaminant from the air, and/or that a filter cartridge may contain multiple sorbent materials designed for different contaminants. E.g. a filter may have a first sorbent, designed to filter a first contaminant, and a second sorbent, designed to filter a second contaminant. Such a filter may be useful for an environment where multiple contaminants are present. For example, the first contaminant may be present in a first area and the second contaminant in a second area, or both contaminants may be present in a third area. A single filter designed to adsorb both first and second contaminants, either with a single sorbent or multiple, would allow for more job flexibility in either scenario, as a worker can move between the first and second areas without having to change PPE.

Similarly, it is also expressly contemplated that a first sorbent may adsorb both the first contaminant and a third contaminant. For example, toluene and acetone can adsorb on the same time of sorbent, but toluene is more likely to be adsorbed. This can cause breakthrough of acetone more rapidly. The term “concentration” may refer to a combined concentration of contaminants in such embodiments.

It is therefore expressly contemplated that systems and methods herein may apply to a multi-contaminant scenario, such that filter loading predictions are calculated for each contaminant separately

The term “sorbent” refers to a second substance that sorbs the first substance by adsorbing, absorbing, or both. The sorbent can interact with the first substance being sorbed by physisorption, chemisorption, or both. Sometimes the term “demand substance” may be used to refer to a substance capable of adsorbing gas and vapor. Suitable demand substances are described in U.S. Pat. No. 9,291,484 (assigned to 3M). Examples of sorbent materials include, for example, activated carbon, treated activated carbon, alumina, silica gel, hopcalite, molecular sieves, metal-organic frameworks, or a combination thereof.

The term “sorbent bed” refers to a volume of sorbent substance that is packed in a defined shape in a filter. The sorbent bed may have multiple sorbent materials layered or mixed. The bed may be formed with other non-sorbent materials such as fibers and/or binders. The bed can take on various geometric shapes. It may also be referred to “filter bed”.

The term “adsorption capacity” refers to the amount of adsorbate taken up or adsorbed by the adsorbent per unit mass (or volume) of the sorbent bed. The “maximum adsorption capacity” or “Total capacity” describes the amount of adsorbate on sorbent when all of the adsorption sites (micro, meso, and macropores) are filled with the adsorbate.

The term “adsorption factor” refers to any parameter that directly affects an adsorption rate of a sorbent bed.

The term “service life” refers to the amount of time that sorbent bed in a filter adsorbs a given gas and vapor contaminant under certain (temperature and relative humidity) condition till either the contaminant concentration exiting or leaving the filter reaches a pre-set limit or after a pre-set time duration.

The term “residual life”, refers to the difference between maximum service life and used service life for a given gas and vapor contaminant. Sometimes the difference is also referred to as “remaining capacity” or “residual capacity”, when comparing the used adsorption capacity to maximum adsorption capacity prior to filter reaching service life. The terms of residual life and remaining life capacity are inter-exchangeable.

The difference may be expressed in terms of time or percentage.

The term “and/or” means either or both. For example, “A and/or B” means only A, only B. or both A and B.

Systems and methods described herein refer to the use of computer-based models and/or computer-based simulators. Said models or simulators may be based on one or more algorithms, may incorporate machine learning, or otherwise may be used to model or simulate conditions. As described herein, in some instances, some parameters may be estimated while others are retrieved from available information—e.g. databases, sensor signals, etc. Said models or simulators may be executed by a processor that may be local to a device, on a remote datastore, in a cloud based datastore, or otherwise suitably accessible.

Previous methods to improve estimates of remaining filter adsorption capacity have included linear models. Other solutions (such as the 3M 6001 i gas and vapor cartridge) incorporate sensors in a respirator filter to detect chemical exposure at a certain point in the sorbent bed, or within the filter itself. However, many such sensors typically can only respond to a small fraction of the potential hazards and may be expensive, or require space within the device or require battery life. A better solution for more realistic, in-situ modeling or simulation of adsorption rates is needed to ensure that used filters are replaced before a worker is exposed to a harmful material. Systems and methods herein provide for more accurate simulation of filter loading, using sensor(s) or other information retrieved in real-time to update a simulation as available. Some previous methods have retrieved real-time information and made worst-case scenarios for parameter values, based on a snapshot of conditions or parameters at the current time.

U.S. Provisional Application Ser. No. 63/264851. filed Dec. 3. 2021. describes systems and methods for providing a real-time capacity estimation for a filter, that uses known information about a current environment to estimate the remaining capacity for the filter. For example, the system may use a known temperature gas and vapor composition and concentration, received from sensors in an environment, to provide a real-time capacity estimation.

Described herein are systems and methods that provide forward looking adsorption rate predictions based on predicted changing patterns of environmental conditions or parameters. While real-time capacity estimations are useful and more accurate than previous methods it requires updating the estimate as parameter values change. In some embodiments, systems and methods herein make forward predictions about parameter values, and use those predicted trends to generate a predicted capacity estimation. Systems and methods herein utilize machine learning to understand and predict parameter trends over time, based on known trends or available predictions. As a simple example, systems and methods herein may retrieve hazardous chemical concentration report for a manufacturing line or a maintenance process or a gassy mine. It may be expected that the hazard concentration will rise or drop based on historical knowledge or detected pattern or certain operations during start-up or shut down or trouble shooting. The system herein can make several service life predictions based on different trend scenarios, such as continuation of current changing pattern of rising concentration, or decrease of hazard concentration due to certain actions or intervention. The trend may be in a linear pattern, or exponential pattern, or repeated step function, or sinusoidal pattern, etc. Additionally, based on known rules, safety protocols, or past worker history, systems herein may predict that a user will need to take actions such as leaving the environment and taking shelter in a designated area, within a predicted time based on the scenario. Therefore, a forward prediction of adsorption rates, at the very least, includes trending the hazard concentration, breathing or flow rate through filters, and potentially other factors such as temperature and relative humidity based on a weather forecast.

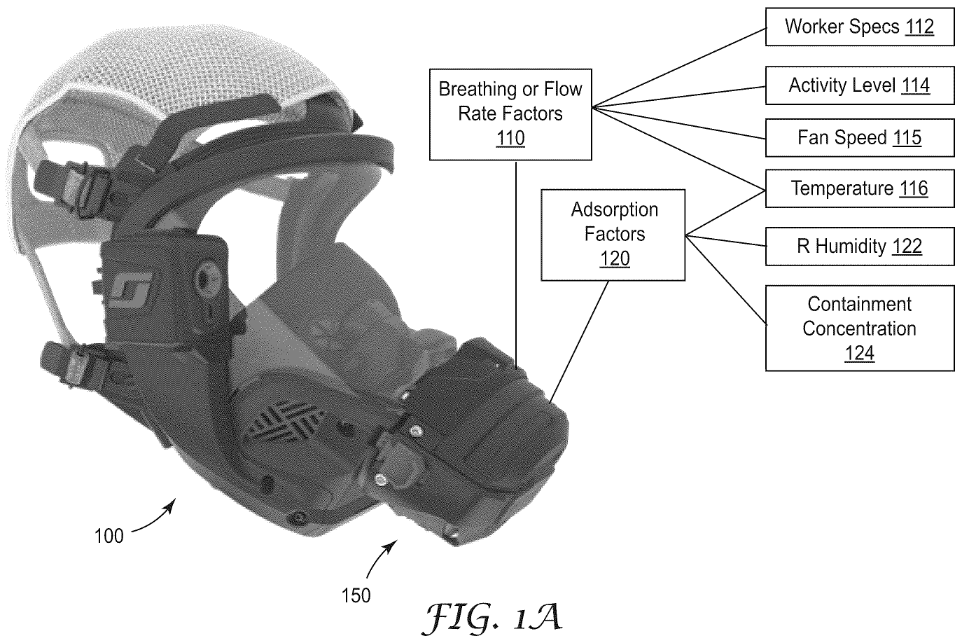

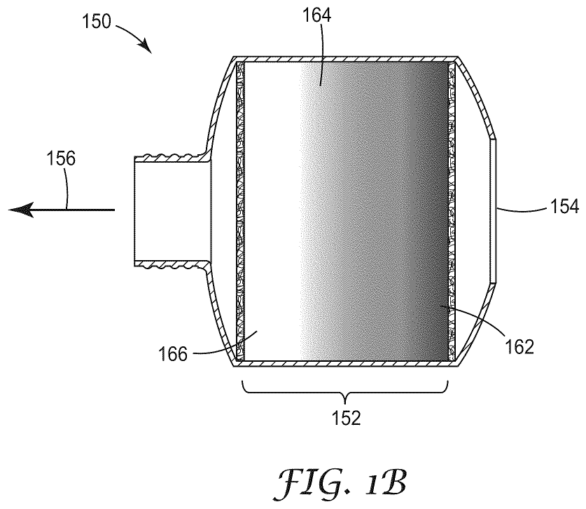

FIGS. 1A-1B illustrate a PPE device in which embodiments herein may be useful. FIG. 1A illustrates a respirator 100 with a filter cartridge 150 and a full-face shield. However, it is expressly contemplated that embodiments herein may be implemented with more than one and other filtering devices and other headgear. Additionally, more or less PPE may be present in some embodiments. such as communication devices integrated into, or separate from, PPE (shown as a respirator) 100; hearing protection integrated into, or separate from, respirator 100; eye and face protection integrated into, or separate from, respirator 100, helmet or other head protection integrated into, or separate from, respirator 100, etc. Additionally, a wearer of PPE 100 may also have other devices that are communicably coupled to respirator 100 or to a central hub, for example using a wireless network such as WiFi™, Bluetooth®, NFC, RFID, etc. or through a wired communication link. PPE 100 may optionally comprise a HUD (Heads Up Display) providing real-time visual update of the remaining filter capacity detection system data to the PPE wearer.

Respirator 100 is designed to seal a wearer from the environment and to remove hazardous gas and vapors from ambient air using filter cartridge 150. Filter cartridge 150 houses an adsorbent bed, with a sorbent material that removes hazards from the air as a user breaths, or as air is provided to the user, e.g. using a fan, etc. The adsorption rate, as illustrated, is generally based on breathing or flow rate factors 110 and adsorption factors 120.

Breathing or flow rate factors 110 include worker specifications 112—e.g. men generally have a higher breath rate than women, and larger individuals have a larger breath rate than smaller individuals. Worker specifications may include a height, weight, BMI, past breathing rates, etc.

Breathing or flow rate factors 110 may also include activity level 114. For example, a worker undergoing a strenuous activity—e.g. running or walking quickly, carrying items, wearing heavy equipment, will have a faster breathing rate than those doing less strenuous activity, such as standing or sitting.

Temperature 116 can affect both a breathing (or flow) rate and an adsorption rate. For example. many adsorption rates are temperature dependent, and humans tend to breath faster when the temperature is higher. Relative humidity 122 and atmospheric pressure may also affect a breathing rate, but also is an adsorption factor 120, affecting an adsorption rate of a sorbent in filter cartridge 150. Adsorption factors 120 also include a concentration of a contaminant 124. It is noted that, for some sorbents, adsorption capacity increases as concentration increases above a threshold.

Factors 114-124 may be forecast, based on known environment, climate and weather information, known worker information and known activity levels of the worker. Such information may be accessible to systems herein. For example, a processor associated with device 100, or communicably coupled to device 100. may retrieve such information from a database of site-related and worker-related information and, based on that information, provide forward predictions of breathing rate factors and adsorption factors.

FIG. 1B illustrates a schematic of a cross-sectional view of a filter. Contaminated air is received through an air intake 154, where it passes through a sorbent bed 152. The sorbent bed is made of material(s) that is designed to adsorb contaminants from the ambient environment, such as, hazardous inorganic and organic gas and vapors. The filtered air exits as indicated by arrow 156, where it is breathed in by a wearer of PPE 100. Filter sorbent bed 152, as it is used, has a concentration profile of the hazardous gas or vapor as illustrated in FIG. 1B. As illustrated in FIG. 1B a concentration profile forms as filter bed 152 filters an air stream and contaminant gas or vapor is being adsorbed to the bed, with a fully loaded portion 162 at an air intake side of filter 150, and an unloaded portion 166 at a respirator coupling side of filter 150. As illustrated in FIG. 1B, at least a portion of sorbent bed 152 is partially loaded 164.

The leading edge of a concentration profile will reach the air-exiting edge of adsorbent bed 152 before the entire length of adsorbent bed 152 is fully loaded. When the adsorbent bed 152 is partially loaded, a filter may no longer provides adequate protection, and the worker maybe exposed to the hazardous contaminant. The amount of acceptable breakthrough depends on the contaminant and exposure threshold levels. For example, filters may be considered useable, in some cases, up to 1%, 10% or even 50% breakthrough. However, up until a breakthrough threshold is reached, a filter is still useable. However, estimating how a concentration profile has progressed through bed 152, and when breakthrough will occur, is difficult as the concentration profile is dependent on a number of variables that change during a shift, including concentration of hazardous gas and vapor contaminants throughout an environment, temperature, flow rate (e.g. breathing rate of a wearer of PPE 100), relative humidity, and atmospheric pressure, to name a few. Depending on the environment of a worksite, an average usable time for a filter can vary wildly, from only a few hours. to a whole shift, to multiple shifts. For some worksites, these parameters may vary enough that workers in a first area have a significantly different expected service life for the same filter than a worker in a near-by area. The common practice of replacing air purifying filters after a certain period of time in service does not take those variations into account. A better method for estimating remaining capacity or residual service life is needed to assist in keeping all workers in an environment safe.

In some embodiments, a real-time capacity estimation and a predicted capacity estimation of a filter 150 are estimated using an algorithm and a set of mathematical models with default parameter values that are updateable based on expected or estimated trends. The algorithm may have analytical, numerical, empirical, or semiempirical adsorption models using algebraic equation, differential equation, or data regression for examples. A model for sorbent bed 152 can be created to simulate how the filter is being used based on known, and estimated, future parameter values.

For example, specifications of a particular filter can be known from a manufacturer. In some embodiments, a set of default parameter values are used for user and environmental estimates. However, in some embodiments, the model can receive from sensors or other indicia of environmental or user information and replace default parameter values with known values.

The model also uses retrieved trend information, or other indicators to predict what future parameter values will be. Then, using the parameter trends, a predicted capacity estimation at a given future time can be generated using the model.

In some embodiments further still, the model is periodically updated to provide more accurate concentration profile estimates and predicted capacity estimates. Periodically, or continuously, updated parameter value information can be sought and the model updated. For example, as the contaminant concentration gradually increases over time, it may be predicted as trending upward and a future concentration based on the upward trend, instead of the currently detected concentration, may be used for predicted capacity estimates in the model.

In another example, the barometric pressure or temperature information may come from a sensor associated with PPE device 100, with another PPE device, with a sensor in a worksite, or may be retrieved from a weather service, or over the internet from a weather prediction website for the area. Similarly, flow rate for the filter may be estimated based on a known height, weight and gender of a wearer using OSHA generated estimated breath rate. In a further example, multiple parameters are tracked and a combination of trends are used in predicting adsorption capacity estimates at a future time.

For a real-time capacity estimate, an actual breathing rate can be used if available, for example based on breathing sounds captured by a microphone associated with PPE device 100 or another PPE device, or based on a heartrate obtained from a fitness device or other physiological monitoring device, or based on a sensor signal. Additionally, flow rate for a positive pressure respirator such as a PAPR can be estimated by the blower setting, hood fit, and filter loading, battery usage, or be retrieved per manufacturer's claim. Additionally, a predicted capacity estimate may be generated if historical breathing rate trends for a user are available, or if it is known that the worker is completing a high or low stress job that may result in faster or slower breathing rate due to fatigue levels.

As illustrated in FIG. 1A, the simulation model may be updated based on sensor signals within the worksite, such signals from concentration sensors 124, which provide indicia of concentration levels at different points within the worksite. The model may also have access to trend information for parameters that can be retrieved from a database, over a network, based on manual input, such as historic concentration levels within the same worksite.

While many forms of simulation models may be used, one example is a partial differential equation model that, as derived below, can be used to solve for the concentration profile of adsorbent bed 152.

The basic equation of mass balance for adsorbate in a fixed adsorption bed is:

(Accumulation in adsorbed phase)+(Accumulation in gas phase)=(Net flow in by convection)+(Net flow in by diffusion dispersion) Equation 1

\For a fixed bed process with axial dispersion and no pore diffusion, we have the following sorbate material balance (Ding, F. 2020):\

$${ρ}_{b} \frac{d q}{d t} + ε \frac{\partial c}{\partial t} = - v \frac{\partial c}{\partial z} + D \frac{{\partial }^{2} c}{\partial {z}^{2}} \qquad Equation 2$$

where q is the adsorbate concentration in the adsorbed phase, c is adsorbate concentration in the gas phase, t is time, z is distance in the sorbent bed from the air entrance to exit, ρ_{b} is the packing density, and D is the apparent axial dispersion coefficient for a forced breakthrough bed operation and gas phase diffusion coefficient for a static bed.

The uploading rate is related to the concentrations via Linear Driving Force (LDF) approximation. One form is given according to the Ruthven linear driving force approximation, provided as Equation 3.

$$\frac{d q}{d t} = {k}_{R} ( {q}_{e} - q ) \qquad Equation 3$$

Where k_{R} is the LDF coefficient. Ding proposed a concentration LDF form as (Ding, F. 2020).

$${ρ}_{b} \frac{d q}{d t} = {k}_{D} ( c - {c}_{s} ) \qquad Equation 4$$

Where k_{D} is the surface diffusion coefficient for the chemical. Equation 4 is derived by Fick's diffusion model at the surface of the sorbent particle.

The boundary conditions are described below in Equation 5:

$$\{ \begin{matrix}c = {c}_{f} & Feed End \\ \frac{\partial c}{\partial z} = 0 & Effluent End\end{matrix} \qquad Equation 5$$

The governing or controlling partial differential equations are solved using numerical method to give out the simulation of the evolving process of the bed concentration profiles over time, and the results can be visualized to the user in substantially real-time, and the remaining capacity or a residual life can be estimated, based on current or predicted parameter values. Based on concentration profile estimates, an end of service life warning can be issued ahead of time when the estimated capacity is close to a preset threshold.

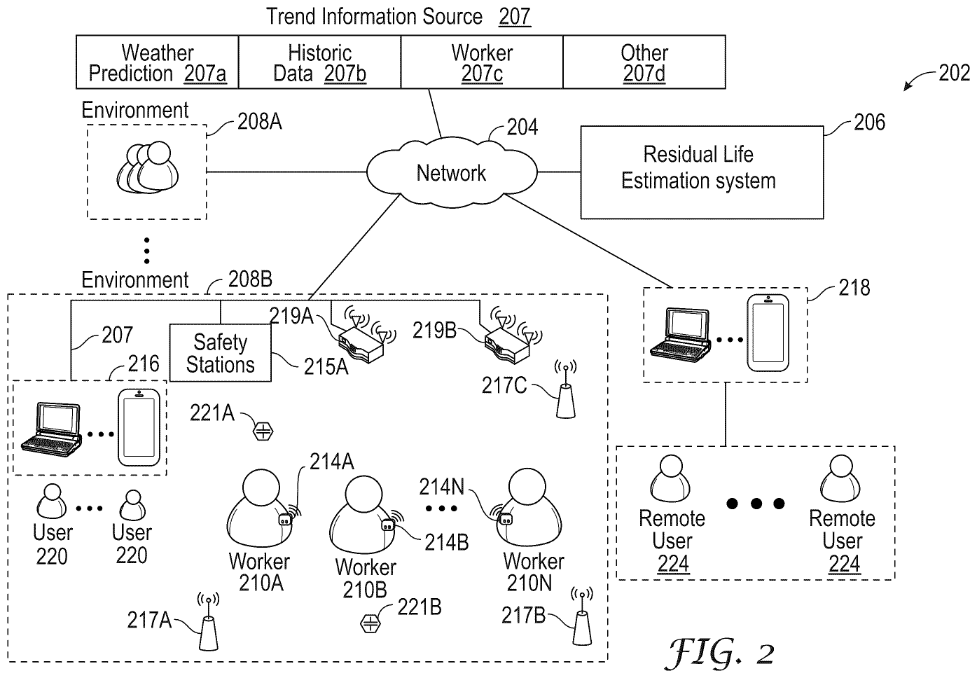

FIG. 2 illustrates a worksite in which embodiments of the present invention may be useful. FIG. 2 is a block diagram illustrating an example network environment 202 for a worksite 208A or 208B. The worksite environments 208A and 208B may have one or more workers 210A-210N, each of which may need to interact with equipment or environments that require the use of personal protective equipment such as glasses, hard hats, fall protection equipment, respirators, gloves, etc. Workers 210A-210N may have a range of experience with a given worksite, with some knowing and complying with rules concerning personal protective equipment, and others who do not know, are still in training, or actively not complying with personal protective equipment requirements.

Environments 202 includes a filter capacity estimation system 206 for detecting and managing compliance with filter replacement requirements. FIG. 2 illustrates an embodiment where a centrally located capacity estimation system 206 is in communication with workers 210A-210N, for example using displays within environment 208B, communicatively coupled PPE or other devices, such as cellular phones, Land Mobile Radios, etc. However, this is by illustration only. Capacity estimation system 206 may generate a real-time capacity estimate, based on currently known parameter values, or a predicted capacity estimation, based on predicted future parameter values, or both values. While it may be useful for large sites to have one central system that calculates 20) and monitors filter capacity for a number of respirators, systems and methods herein can also be implemented in other configurations, as described with regard to later Figures.

System 206 may be connected, through network 204, to one or more devices or displays 216 within an environment, or devices or displays 218, remote from an environment. System 206 may provide alerts to workers 210A-210N when a filter needs to be changed. System 206 may also be integrated into entry protocols for different areas within an environment such that positional information of each worker 210A-210N, and associated environmental information regarding a known position, is known.

As illustrated in FIG. 2, capacity estimation system 206 may interact with a trend information source 207 to obtain information on which to base predictions of site parameter values. Trend information source 207 is illustrated in FIG. 2 as a single database or information source, however it is expressly contemplated that information may be retrieved from multiple sources. For example, weather prediction information 207a may come from a local weather prediction source, retrieved over the internet, retrieved via satellite, or through another source. In contrast, historic information may be retrieved from a site 207b, from a given PPE, or another source. Worker information 207c may be retrieved from a worker, for example through an application interface on a smart phone or other computing device, through a keypad or other input device, through a voice interface, or from a worker database. Other relevant information 207d such as start-up or maintenance operations may also be retrievable and used as the basis for parameter trend prediction.

As shown in the example of FIG. 2, a computing device within a plurality of physical environments 208A, 208B (collectively, environments 208) electronically communicate with system 206 via one or more computer networks 204. Each of physical environments 208A and 208B represents a physical environment, such as a work environment, in which one or more individuals, such as workers 210, utilize personal protection equipment while engaging in tasks or activities within the respective environment. A computing device may also communicate with one or more environmental sensors within environment 208B. For example, contaminant concentration sensors may be distributed at fixed points throughout an area so that contaminant concentrations are retrievable for each of the fixed points. Capacity estimation system 206 may, based on the known contaminant concentrations, generate a real-time capacity estimation by replacing a default concentration with a known or estimated current contaminant concentration. For example, if a user is halfway between Point 1 and Point 2. an estimated contaminant concentration that averages the concentrations at Point 1 and Point 2 may be used. Other estimation methods may also be used, such as logarithmic estimations, fixed concentration estimates, etc. In another example, if a user goes from environment 208A to 208B and back and forth, the measured and/or estimated contaminant concentrations reflecting each environment's condition, coupled with the actual filter use time and breathing rate or flow rate in each environment, can be used. As described herein, capacity estimation system 206 may also, based on predicted future values of the concentration, generate a predicted capacity estimation. The predicted future values may be based on historic concentration data (e.g. concentrations increasing during tank access for maintenance in shutdown season in oil and gas applications, or potential concentration increase due to leaks while workers connect to tank cars). worker data (e.g. worker assignment near Point 2 for the next 2 hours before returning to Point 1), or another suitable source.

In this example, environment 208A is shown as generally as having workers 210A-N, while environment 208B is shown in expanded form to provide a more detailed example. In the example of FIG. 2, a plurality of workers 210A-210N may be wearing a variety of different PPE, such as earmuff hearing protectors, in-ear hearing protectors, hard hats, gloves, glasses, goggles, masks, respirators, hairnets, scrubs, or any other suitable personal protective equipment.

In some embodiments herein, an article of PPE may include one or more of embedded sensors, communication components, monitoring devices and processing electronics. In addition, each article of PPE may include one or more output devices for outputting data that is indicative of operation of the PPE and/or generating and outputting communications to the respective worker 210. For example, PPE may include one or more devices to generate audible feedback (e.g., one or more speakers or bone conduction transducers), visual feedback (e.g., one or more displays or display types, heads up display (HUD) in a virtual reality or augmented reality (collectively known as XR) device such as a look through or look-at in-mask display built into a PPE or coupled to a PPE device, light emitting diodes (LEDs) or the like), or tactile feedback (e.g., a device that vibrates or provides other haptic feedback). Examples of in-mask displays are illustrated in U.S. Pat. No. 10.864.392. issued on Dec. 15. 2020. incorporated herein by reference.

In embodiments herein, workers 210A-210N may require a respirator with a filter in at least some areas of environment 208A. However, workers 210A-210N may also wear other PPE, which may be communicably coupled to a respirator and/or system 206. As described herein, while system 206 may provide simulated capacity or concentration profile estimates for filters associated with each of workers 210A-210N, said estimates can be more current and accurate with additional sensor information. For example, a hearing protection unit may have a microphone that can be used to get an accurate breath rate of a wearer. Similarly, full and half face respirators, as well as any other PPE devices with communications (e.g. microphone and/or speaker) built in or communicably coupled. This is discussed in greater detail, for example, in Published PCT Application WO2020/128952.

Alternatively, a harness, such as fall protection harness, may provide respiration rate of the worker, or any PPE worn by the worker may be equipped with a motion sensor to provide work rate of the wearer. As described herein, other PPE or devices associated with a worker, such as a smart phone, Land Mobile Radio, smart watch, or other communicably coupled device, may have internal or external sensors that can provide useful information for providing more accurate concentration profiles for filters associated with workers 210A-210N.

Similarly, environment 208B may also have a number of fixed or mobile sensors 221A, 221B. Sensors 221A and 221B may be temperature sensors, barometric pressure sensors, relative humidity sensors, gas or vapor concentration detectors or another environmental sensor. If sensors are mobile they may be carried by worker 210 or attached to a PPE worn by worker 210.

In some examples, each of environments 208 include computing facilities, such as displays 216, or through associated PPEs, by which workers 210 can interact with system 206. For example, an alert can be presented on display 216 if worker 210B needs to replace a filter. For examples, environments 208 may be configured with wireless technology, such as 802.11 wireless networks, 802.15 ZigBee networks, LoRa, Ultra-Wide Band (UWB), LTE, and the like. In the example of FIG. 2, environment 208B includes a local network 207 that provides a packet-based transport medium for communicating with system 206 via network 204. In addition, environment 208B includes a plurality of wireless access points 219A, 219B that may be geographically distributed throughout the environment to provide support for wireless communications throughout the work environment.

As shown in the example of FIG. 2, an environment, such as environment 208B, may also include one or more wireless-enabled beacons, such as beacons 217A-217C, that provide accurate location information within the work environment. For example, beacons 217A-217C may be GPS-enabled such that a controller within the respective beacon may be able to precisely determine the position of the respective beacon. Alternatively, beacons 217A-217C may include a pre-programmed identifier that is associated in system 206 with a particular location. Based on wireless communications with one or more of beacons 217, or data hub 214 worn by a worker 210 is configured to determine the location of the worker within work environment 208B. In this way, sensor information provided to system 206 may be stamped with positional information. This may be helpful to estimate current or future parameter values for a worker 210A moving throughout environment 208B. For example, if concentration of a hazardous material is high at 221B and low at 221A, an estimated concentration is likely higher for a worker closer to 221B than for a worker closer to 221A. For a worker moving from 221B to 221A, an estimated concentration that the worker is exposed to can be calculated, and provided to system 206, which may calculate a more accurate concentration profile for a filter associated with the worker than would be available without the concentration estimates.

In some implementations, an environment, such as environment 208B, may also include one or more safety stations 215 distributed throughout the environment to provide viewing stations for accessing calculations from system 206, or to obtain a replacement filter. Safety stations 215 may allow one of workers 210 to check out articles of PPE and/or other safety equipment, verify that safety equipment is appropriate for a particular one of environments 208, and/or exchange data. For example, safety stations 215 may transmit alert rules, software updates, or firmware updates to articles of PPE or other equipment.

In addition, each of environments 208 include computing facilities that provide an operating environment for end-user computing devices 216 for interacting with residual life estimation system 206 via network 204. For example, each of environments 208 typically includes one or more safety managers or supervisors, represented by users 220 or remote users 224, are responsible for overseeing safety compliance within the environment. In general, each user 220 or 224 interacts with computing devices 216, 218 to access system 206. For example, the end-user computing devices 216, 218 may be laptops, desktop computers, mobile devices such as tablets or so-called smart cellular phones.

Users 220, 224 may interact with system 206 to control and actively manage many aspects of safely equipment utilized by workers' 210, such as accessing and viewing environmental parameter history, workers' 210 history, such as filter replacement history, or other records, analytics and reporting. They may also base on the predicted capacity estimates by system 206, such as unusually high concentration or low breath rate to determine possible causes for next actions for workers 210.

System 206 may be configured to actively monitor sensors 221, workers 210A-210N and other users 220 within an environment 208 for updated information that could affect filter concentration profiles. For example, system 206 may receive an indication that contaminant concentration has risen, or that relative humidity has dropped, or that a worker's breath rate has increased and thus react accordingly and modify the initial remaining capacity estimate.

System 206 may further trigger an alert if an estimated concentration threshold passes a threshold, or an estimated service life end is near. The alert may be sent to worker 210, either through a communication feature of a PPE, a separate communication device, or through a public address system within the environment. The alert may also be sent to a supervisor or safety officer associated with the environment 208 as well. Alerts may also be tracked and stored within a database, as described herein.

Currently, safety managers, supervisors, etc. may suggest a replacement schedule based on use conditions entered by users into a software program such as 3M Select and Service Life Software. However, this is often just a best available estimate of a number of hours that a filter may be used. The end-user is then responsible for counting the number of hours used regardless of changes in use and environment condition parameters, and to change the filter out when its estimated useful life is expired. This requires a user to log hours where a filter is exposed to the given customer conditions. But if a filter is accidentally left in an area where it may be exposed to toxic or hazardous chemicals, the concentration profile may progress towards breakthrough even though a user is not wearing it. Similarly, even if left in an area without exposure to toxic or hazardous chemicals, migration may still occur. Capturing such information, in addition to unexpected concentration dips or surges, is crucial for providing more accurate filter concentration profile information. In some embodiments, a “running clock” is used so that estimates are based on actual exposure time for contaminants known to easily migrate.

Traditional methods attempting to simulate concentration profiles of a filter rely on constant site and worker activity conditions and often use an algebraic model to simulate. A system is desired that can track varying conditions and predict concentration profiles not only based on the tracked varying conditions but also ahead of time based on the predicted changing trends to enable earlier and forward looking alerts. The forward-looking alerts may be an early warning of real life event such as tank or pipe leaking or PPE malfunctioning. Systems and methods described herein enable current and forward-estimating concentration profiles based on changing environmental or worksite conditions both by detecting and/or predicting changes in environmental or worksite conditions. Based on updated environmental and worksite conditions, concentration profiles can be repeatedly simulated and updated, providing a simulation that is closer to the real concentration profile currently present in a filter and an estimate of what may be present in a filter in the future based on the trend. Embodiments herein can provide current and future simulation data without requiring a chemical sensor within a filter cartridge or a PPE device, reducing cost and device complexity while providing more accurate results.

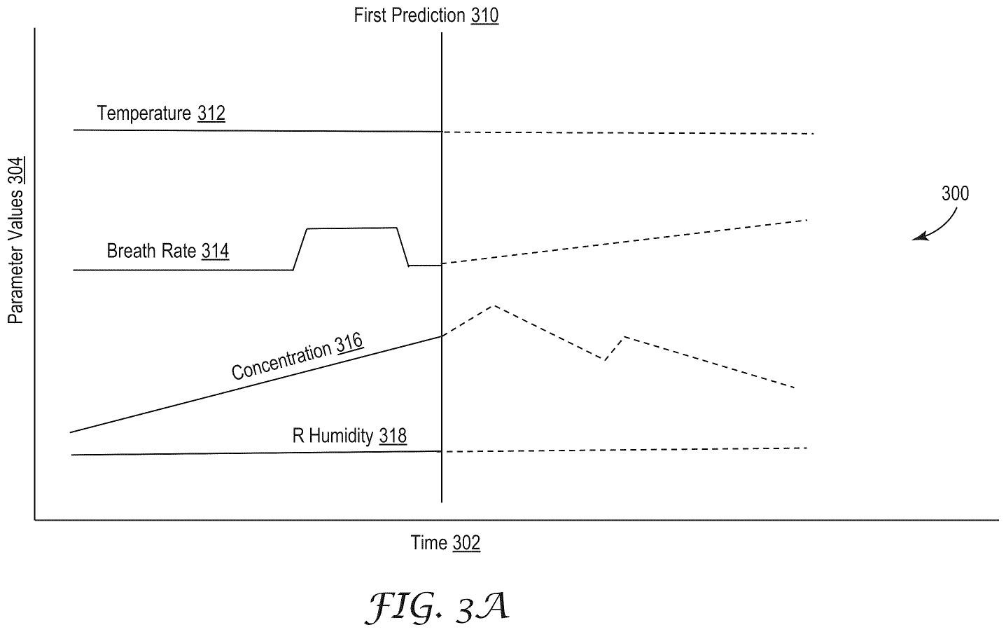

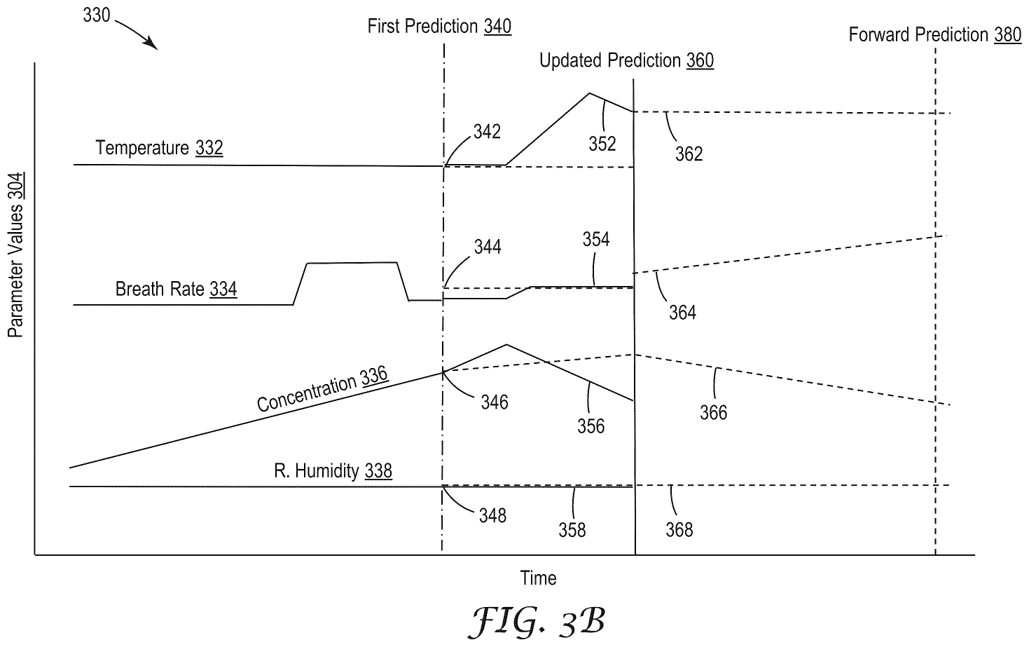

FIGS. 3A and 3B illustrate operation of a parameter prediction system in accordance with embodiments herein. These parameters are then used to calculate a new more accurate remaining adsorption capacity or service life. FIG. 3A illustrates a chart 300 where a first prediction 310 is made after a certain amount of elapsed time 302, for a number of parameters 304. The parameter information to the left of first prediction 310 (e.g. prior to the time the first prediction 310 was made) may have been obtained by sensor information in an environment, sensors associated with a PPE containing the relevant filter cartridge or other methods previously disclosed. At a time first prediction 310 is made, a real-time capacity estimation may be made, for example based on a temperature 312, breath rate 314, concentration 316, and relative humidity 318 at the time of first prediction 310.

As illustrated, prior to a time the first prediction 310 of filter loading is made after a period of time where the temperature 312 remained constant, the breathing rate 314 of a worker experienced a minor increase before returning to a previous level, a concentration 316 steadily increased, and a relative humidity 318 remained constant.

Systems and methods may have access to historic data for parameters 304 and make trend predictions (the portion of chart 300 to the right of first prediction) based on historic, or worst-case estimates. For example, as predicted in FIG. 3A, temperature and relative humidity may be expected to remain relatively constant, as historical data suggests, concentration may be expected to reach to a maximum then taper off, and a breathing rate steadily increases, based on previous data.

In some embodiments, as illustrated in chart 330 of FIG. 3B, systems and methods herein can, using machine learning, artificial intelligence or by referring to historic patterns. learn trends in parameter values and improve predictions over time. As illustrated, a first prediction 340 is made based on parameter trends at that time, e.g. after a similar passage of time as first prediction 310. However, predicted values 342-348 may be adjusted, at a second time prediction 360, and new predicted parameter trends 362-368, are made based on newly collected data 352-358. Therefore, forward prediction 380 can be made based on new parameter trends 362-368 at the time of prediction 360. The passage of time between prediction 360 and 380 may be pre-set or determined by user input. These adsorption capacity predictions based on parameter trends are in addition to capacity estimates based on retrieved actual parameter values at the time of estimation.

Parameter trends may include any suitable modeling—for example step functions to model moving from a first area to a second area where temperature/concentration/etc. differ. A linear function may be useful for parameters that are expected to vary linearly, like temperature increases and decreases in an outdoor environment. Similarly, a sine or cosine model may be used for parameters that are expected to vary cyclically, etc. Combinations of functions may also be used, where appropriate.

Machine Learning may include the recording of historic usage and environmental conditions and using the historic data to make prediction of the current work session. It also may include adjusting mathematical modeling, and model parameters to better predict the work session performance. Collected information of the current session will be collected and used by Machine Learning to repeatedly adjust the said environmental conditions, mathematical modeling, and model parameters.

At both first time prediction 340 and second time prediction 360, a predicted capacity estimation system, in addition to historic information, may also be able to access trend information for a site, physical location, or a worker and make forward predictions. While many prior art systems do a best/worst case estimate to obtain a maximum and minimum service time remaining, systems and methods herein have the ability to utilize a wider variety of data sources to make predictions of future behavior that is more accurate than previous estimates. Increased accuracy not only may allow for a filter to be used for the full service life, but may also provide a more accurate estimation of how much longer a filter can be used based on current and predicted parameter values, providing an alert in the event a filter capacity is used more quickly than expected. Additionally, accuracy may also ensure that a filter is removed if it does experience faster loading due to changing conditions, ensuring the safety of the worker.

For example, as illustrated in FIG. 3B, a worker started an operation or left a first area for a second area, resulting in the quick change in concentration parameter. Based on known information about the worker's work assignment, for example, it is known that they have moved to a location where gas concentrations are higher, and the temperature is lower. At updated prediction time 360, these values remain constant in accordance with known information that the concentration levels and temperature remain relatively constant in the indoor area.

The breathing rate, however, is predicted to steadily increase, as illustrated by prediction 364, as the worker is assigned a work detail that has previously caused them to exhibit a similar breath rate profile.

Systems and methods herein can refer to stored trends of maximum and minimum parameter values, for example temperature bounded by climate/weather maximum and minimums, likely or real experienced concentration maximum and minimum for a site. Additionally, systems and methods herein can refer to known trends—e.g. a worker's breath rate history retrieved from previous shifts worked with similar work assignment and temperature/humidity conditions. Based on known actual parameter values and known historical data, systems and methods herein generate expected parameter trends for relevant parameters and, based on those expected trends, generate a more accurate estimate of filter loading.

Systems and methods may also, in some embodiments as illustrated in FIG. 3B, update the prediction with additional data as it is available and/or received. For example, updated weather forecasts, change in work detail, etc.

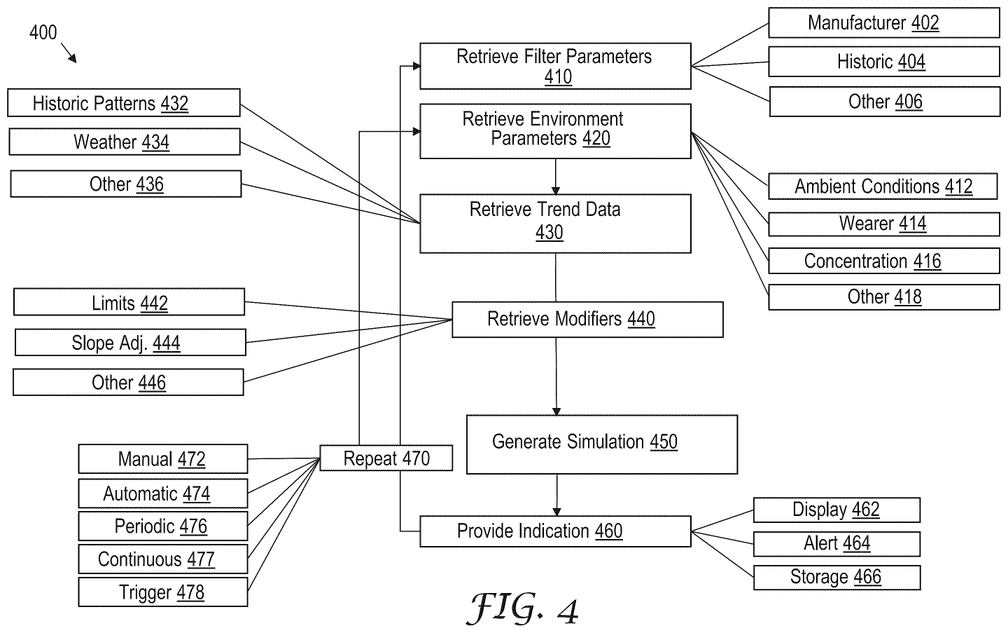

FIG. 4 illustrates a method of generating a predicted capacity estimation for a filter in accordance with embodiments herein. Method 400 may be implemented locally on a processing unit within a PPE device, such as a respirator or within a filter cartridge unit, or as part of other filter-containing device. Method 400 may also be implemented using a computing device remote from a respirator, for example on a separate device such as a mobile computing device (smart phone, tablet, laptop, etc.) associated with a wearer of the filter, or with another worker or supervisor in an environment. Method 400 may also be implemented on a computing device located remotely from a respirator.

A benefit of method 400, over other prior art methods of estimating or detecting a concentration profile or breakthrough, is that it may operate without a sensor within the filter cartridge unit, respirator mask, PPE, or environment. While a simulation result of method 400 may be made more accurate by providing real-time sensor data related to the environment, no real-time sensor feedback is required as calculations can be done using historic data or other set defaults. Simulations using methods 400 may be able to provide more accurate predictions, without real-time sensor data, because of the use of historic parameter data. For example, there may be sensors in an environment that are not connected to a PPE in real-time.

Predictions can be based on known information, for example historic parameter information, other PPE, weather predictions, or other relevant sources, such as scheduled work assignments and worker parameters.

In block 410, a set of default filter parameter values are retrieved. For example, manufacturer-provided information 402 may be available, including bed parameters such as length, height, width, sorbent amount and type, configuration, label per regulation approvals, etc. Filter information may be retrieved from a manufacturer database, or may be stored locally, for example in an onsite database, in a local storage media of a PPE device, or otherwise readily retrievable using wired, wireless or cloud-based network communications.

Relevant parameters may also be retrieved from a database of historic parameter values 404. For example, an average temperature profile may be selected based on historic values—e.g. an average temperature profile from June of last year may be used to estimate a temperature profile for a date in June of this year. Or an average temperature value from the last month may be used to estimate a temperature in an indoor or outdoor facility. Or yesterday's average measured containment and concentration levels may be used to estimate today's concentration. concentrations. A user's breathing rate parameters may be selected based on a known job assignment, a historic job assignment, or based on a previous day's reading. Or the simulation may update based on readings from earlier in the day, for example.

Other information 406 may also be stored regarding the filter such as a model number, a lot number, a date of manufacture, an expiration date, a presence of an optional particulate pre-filter, a timestamp related to when the filter was purchased, installed, a local regulatory certification, etc. Other information 406 may also include site information, such as planned maintenance or operations or other relevant information.

In block 420, available environmental parameter values are retrieved. The available parameter values may be retrieved from sensors in the area, for example in real-time or periodically. Ambient conditions 412 may be located within a worksite, for example temperature, barometric pressure, relative humidity, or other sensor data. Ambient condition information 412 may also be retrieved using a wireless network, for example from a weather website, satellite information or another source. Ambient conditions 412 also includes projected ambient conditions, where available, such as a weather forecast.

Similarly, information about a wearer 414 of a specific filter may also be retrieved, if available. For example, breathing rate and tidal volume may be estimated based on known wearer information. If a particular wearer is identifiable, their height, weight and gender may be retrieved from a worker database and, in some embodiments, tidal volume is estimated. Similarly, based on work type and work rate, OSHA work rate estimates can be retrieved and used to calculate breathing rate based on worker information. In other embodiments, actual breath rate information may be retrievable, for example based on breath sounds, a flow rate sensor, a visual indication of valve open/closure, physiological harness, or another suitable indication.

Concentration information of hazardous gas and vapors 416 may also be retrieved, for example from worksite contaminant and concentration sensors, or from other sources, such as gas detection sensors associated with a wearer, for example within a respirator or another PPE device. Other sensor information 418 may also be retrieved.

In block 430, trend data is retrieved for environmental parameters. Trend data may be site specific—e.g. an entire worksite environment; or may be environment specific—e.g. specific to environment 208A or 208B; or may be even more specific—e.g. based on a proximity to a source of gas contaminant. For example, trend data may indicate that an environmental parameter is likely to increase, decrease or remain the same over time. Reliable retrieved trend data may increase the accuracy of a capacity estimate for a filter as it may indicate, for example, that an adsorption rate is likely to increase, and filter will need to replaced sooner than otherwise anticipated.

Trend data may include historic patterns 432 of relevant parameter values. Trend data may also include weather forecast 434 for outdoor sites that might dictate a temperature, relative humidity, or a likelihood of an outdoor operation occurring on a given day. Trend data may include projections based on sensor information of parameters over the same use period.

It is also expressly contemplated that trend data may be predicted 436, by a trend simulator using machine learning techniques for example. Other information 438 may also be retrieved, such as expected operations for an indoor site, for example that might change an expected contaminant concentration; or an expected work detail for a specific operator.

Trend data may be used as-is, in some embodiments. However, it may also be modified, as indicated in block 440, by one or more trend modifiers. Trend modifiers may be applied by a simulator based on historical, measured, and regulatory information. For example, a manufacturing process that generate hazardous gas contaminants may have a more rapid generation rate than normally expected, where trend modifier compares to historical trend and regulatory threshold and limit a projected trend to a pre-set maximum at a future time with proposed action to reduce the hazard generation rate. In another example, when petroleum production tank battery is opened during gauging or sampling, the concentrated hydrocarbon gases and vapors (or volatile Organic Vapors—OV) are released and form plume that may disperse or engulf workers atop and around tank batteries. The workers downwind or close by may experience unexpected OV concentration surge. The trend modifier can compare that to historical trend and regulatory threshold and warn user with suggested actions. In a further example, where the detected trend is significantly different from historical trend, for example, much lower breathing rate or near background contaminant concentrations, the trend modifier may prompt user to check for respirator and sensor mis-use, damage, and/or malfunctioning.

In another example, weather predictions 434 indicating a heat wave may cause a slope of a temperature profile to increase to higher maximum than expected, while an incoming storm may dictate a general increase in relative humidity and a rapid decrease in temperature when the storm breaks. Trends may be modified by setting a limit 442, e.g. a maximum likely temperature or a minimum gas concentration threshold. A slope 444 may be adjusted, e.g. to allow for a more rapid increase or a slower decrease. Other modifications 446 are also possible.

In block 450, a predicted capacity estimate is simulated based on available information. A default parameter set is initially used, for example an 8-hour shift in an environment with weather conditions—e.g., 70° F. at 9 AM with 50% relative humidity for the first hour, with the temperature escalating to 85° F. by 2 PM, while the relative humidity remains constant, and at a constant barometric pressure. The weather conditions may be preprogrammed based on historic weather information, climate data, projected weather conditions, or another suitable method. A default concentration of the various containments, for example 100 ppm of toluene, may be set based on expected or historic concentration measurements. Similarly, any of weather information 412, 434 or concentration information 416 may also be retrieved from peer devices, for example other PPE devices, or other sources. In other worksites, such as a factory setting, several fixed site detectors detect information, which is then shared either directly to devices or to a concentration profile simulator.

Then, based on a detected location of a device containing a filter, a best estimate of concentration can be obtained by averaging nearby concentration signals or other estimation procedures. For example, in a distillation site, a worker generally has at least one device, PPE or otherwise, that can provide a GPS sensor signal indicative of a worker location. A concentration profile for the area immediately around the worker can then be estimated based on nearby sensor signals.

Once a concentration profile is obtained, a prediction can be done for each of the parameters. The prediction may also include applying one or more retrieved modifiers, or modifiers may be generated in-situ based on known or retrieved information.

For example, the concentration of a hazardous gas such as acetone or toluene in a work area is reduced significantly when an exhaust fan is activated to increase fresh air intake into said work area.

In another example a large extruder is operating in a work area causing significant increase to the temperature in that area resulting in increase of the vapor pressure of hazardous materials thus potential increasing the concentration of volatile organic vapors. Data can be modified based on prior data of vapor pressure values during extruder operation.

A simulation is generated, in block 450, of a predicted capacity estimate by replacing one or more default parameters or parameter trends with any available actual, or estimated, parameter value information or predicted parameter value information as described above. As described herein, one particular benefit of the embodiments of the present invention is the ability to simulate concentration profiles without the need for sensors on the filter or filter cartridge itself. In the case of a PAPR, this can extend PPE device battery life and reduces overall device complexity and cost, as power is not required for said sensors. In other cases, a battery would need to be added to the device to obtain measurements.

Generating a simulation, in block 450 may also include generating a real-time capacity estimate, based on current parameter values. The real-time capacity estimate may be compared to the predicted capacity estimate, which is based on projected parameter values, and the more conservative estimate may be used as the basis for alerting a user of a need to replace the filter. However, it is expressly contemplated that, in some embodiments, only a predicted capacity estimate is simulated and used as the basis for providing filter placement notifications. The simulation may be done remotely, and results sent to the PPE device, or to a device associated with the PPE-wearer (e.g. an operator's smartphone) in some embodiments. In other embodiments, the simulation is conducted by a processing unit on the PPE.

The simulation may use an algorithm which may have analytical, numerical, empirical, or semiempirical adsorption models using algebraic equation, differential equation, or data regression or another suitable method. For example, the differential equation set above may serve as the model to be solved.

The embodiments described herein are advantageous because a predicted capacity of the filter bed can be estimated quickly, accurately, and updated at regular time intervals as new information is available, providing a forward-looking estimate based on projected conditions.

The integration algorithm requires that the step size be limited to within certain limits such that the integration error is controlled within acceptable range. To respiratory protection applications, this fast speed of calculation provides nearly instant update of the evolving of the contaminant concentration inside the sorbent bed. In environments where concentration varies significantly within an environment, a constantly updated simulation, paired with stored historic simulation data, provides a good picture of how a concentration profile progresses through a filter bed. Additionally, providing a predicted capacity estimate, and re-calculating it based on newly received data, may also help to detect unexpected deviations from a predicted trend. For example, an unexpected spike in concentration may indicate that a different modifier should be applied.

In one embodiment, a partial differential equation solver algorithm provides profile information for a sorbent bed. In embodiments herein, the partial differential equation solver includes or is incorporated into an electronic device having a processor, memory and the algorithm that solves the simulation model.

In block 460, an indication of the predicted concentration estimate is provided. The indication may be provided through a display as indicated in block 462. for example on a heads-up display of a PPE device, on a screen of a computing device such as a smart phone, smart watch, laptop, etc. The display may be updated as new information is available. The indication may also be provided as an alert, as indicated in block 464, for example provided to a worker or their supervisor or a safety officer. An alert may be provided visually, audibly, through haptic feedback or another method or combined methods. The alert may only be provided, in some embodiments, if a threshold is reached, such as an anticipated breakthrough concentration occurring within a specified time limit, or simulated contaminant concentration reaching a certain bed capacity, or contaminant concentration significantly above or below historical average. Other triggering events are also envisioned in some embodiments herein.

As indicated in block 466, the predicted concentration estimate indication may also be provided to a storage, such as a non-volatile memory associated with a computing device. Storage 466 may be local to a PPE device, local within a worksite, part of a second device associated with the same worker, part of a device associated with a supervisor or safety officer, stored in a storage accessible over a wireless or cloud-based network, or another suitable location.

The indication provided in block 460 may be the predicted capacity estimate, a concentration bed profile, or another suitable indication of adsorption progress within a filter adsorbent bed.

In block 470, method 400 repeats, at least in part. As illustrated in FIG. 4 in some embodiments method 400 circles back to block 410 to retrieve parameter information for a filter. This may be helpful in embodiments where a filter replacement is detected, such that parameters relevant to the new filter are retrieved. However, it is also contemplated that, in many embodiments or for much of the time, method 400 repeats with the same filter parameters and proceeds back to block 420, where newly available environmental parameters are retrieved, as discussed above.

Method 400 may repeat based on a manual indication from a user, as indicated in block 472. For example, a user may actuate a predicted capacity estimation system at a beginning of shift, end of break or other standard protocol where a worker is about to enter or leave a worksite. A manual indication may also be input by a safety officer or supervisor to a second device, at a location remote from the worker, and the second device may send a communication to the predicted capacity estimation system.

It is also contemplated that method 400 may initiate or repeat automatically as indicated in block 474, for example based on detection of a user wearing a device containing a filter or detection of air flow rate, for example retrieved through a sensor such as a visual sensor, movement sensor, or other suitable indication.

Repeating, as indicated in block 476, is also contemplated to include repeating the steps of blocks 420, 430, 440, 450 and 460 periodically. The integration algorithm requires that the step size be limited to within a few seconds such that the integration error is controlled within acceptable range. To respiratory protection applications, this fast speed of calculation provides nearly instant update of the evolving of the contaminant concentration inside the sorbent bed. Alternatively, as indicated in block 477, method 400 may repeat substantially continuously, with little or no delay between simulation generation, in block 450, and retrieving updated environmental parameters, in block 420. It may be preferred to continuously search for new environmental parameters, particularly concentration signals relevant to a worker's current location so that no large contamination events go undetected. Similarly, as discussed above, because a worker may be mobile through an environment, they may pass through areas of high or low concentration quickly moving from one area to another within an environment. It is desired to capture such information to provide a more accurate and representative simulation of a concentration profile for a filter.

However, in some embodiments, because the predicted concentration (of each of the various contaminants) estimator relies on likely parameter trend data, it is not necessary to update the simulation as frequently. This may be beneficial in areas where wireless connection is difficult or unavailable and updated information is, therefore, not available. Parameter changes can still be forecast reliably. In such cases, the method may not proceed from block 420 to block 430 unless a parameter value deviates from a predicted parameter value.

However, in embodiments where no sensor information is available, method 400 may only be run when triggered, as indicated in block 478, for example at the start of a shift or when a user first turns on a PPE device containing a filter or when a filter is changed. However, if an indication is received that sensor information, or other new information is available, then block 470 may be triggered to cause a repeat of blocks 420, 430, 440, 450 and 460.

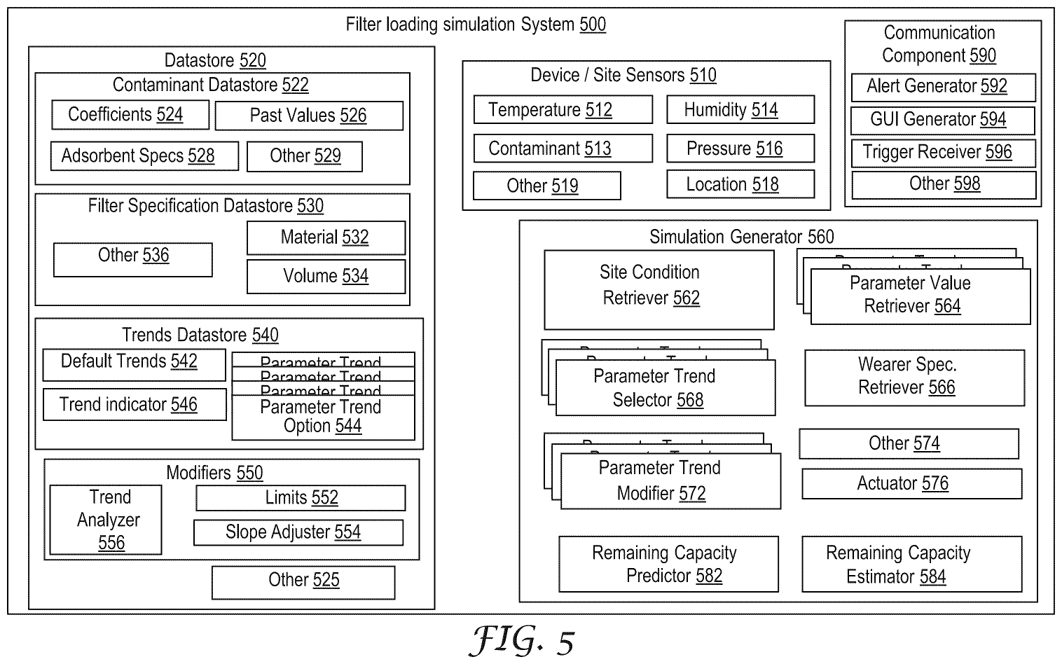

FIG. 5 illustrates a predicted capacity estimation system in accordance with embodiments herein. It is expressly contemplated that, in some embodiments, system 500 is incorporated into a computing unit within the PAPR, in some embodiments. In other embodiments, system 500 is incorporated into an application running on a smart phone associated with an operator of the PAPR of concern. In yet other embodiments, system 500 is remote from the PAPR and communicates capacity estimations and predictions to an operator. In some embodiments, system 500 is not in communication with a PAPR, but communicates only with an operator, e.g. through a smart phone or through displays/speakers in an environment. System 500 may be in communication with a number of sensors 510, or other sources of information relevant to parameter value prediction. Some examples of information sources include temperature sensors 512, contaminant detectors and concentration sensors 513, relative humidity detectors 514, atmospheric pressure sensors 516, location detection 518 for different individuals, PPE and other devices. Other sources 519 may also provide useful information. System 500 may include, or be communicably coupled to, a datastore 520. Datastore 520 is illustrated as part of system 500, in FIG. 5, however it is expressly contemplated that datastore may be remote from system 500 and accessed, for example, using a wireless or cloud-based network. Additionally, datastore 520 is illustrated as including several different stores of information 522, 530, 540, 550—however it is expressly contemplated that at least some of these datastores may be separate from one another and accessed wirelessly or through a cloud-based network.

A contaminant datastore 522 contains information about potential contaminants in an environment, such as coefficients 524 for use in simulating filter loading, adsorbent specifications 528 for an adsorbent material in the filter cartridge, past values 526 for concentration in the environment, and other relevant information 529.

Similarly, a filter cartridge specification datastore 530) may contain information about the filter cartridge, including a sorbent material 532, volume 534, and other information 536, such as previous use, etc.

A trend datastore 540 may include default trends 542 for one or more parameters based on historic data or expected behavior, such as a temperature profile dictated by an air condition system. However, based on retrieved information from sensors 510, a different trend may be indicated, and trend indicator 546 may suggest one or more parameter trend options 544 be selected instead of a default.

Selected parameter trends may be modified, by a trend modifier 572, for example, using one or more modifiers 550. For example, a trend analyzer 556 may review a selected trend, such as a decreasing temperature, and set a limit 552 of a minimum based on efficiency limits of an air conditioning system, or a maximum based on the highest temperature recorded for an outdoor site. Similarly, a slope adjuster 554 may increase or decrease a slope of a trend based on expected changes in the environment or the site.

Datastore 520 may also contain other information 525 such as regulatory thresholds and requirements for hazard contaminants.

Simulation generator 560 retrieves site conditions using site condition retriever 562, either directly from sensors 510 or from datastore 520. Site conditions may include weather, current parameter values, information about what operations are ongoing, etc. Parameter value retriever 564 may retrieve current parameter values, e.g. temperature, relative humidity, concentration, etc. Parameter trend selector 568 may select parameter trends for each relevant parameter, from options 544, for example based on trend indicator 546. Trend modifier 572 may then modify each selected parameter trend, for example using trend analyzer 556.

Parameters based on a wearer of a PAPR may be updated using wearer specification retriever 566, which may retrieve a profile of a current wearer—height, weight, gender—on which to base flow rate estimates, or may retrieve actual vital information, for example from a smart device or sensors associated with the operator that measure breath rate, heart rate, etc.

Simulation generator 560 may also retrieve other information on which to estimate parameter trends and capacity. Based on retrieved information, a real-time capacity is estimated real-time capacity estimator 584. Using retrieved and modified parameter trends, a predicted capacity estimator 582 may provide estimates of an unused capacity of a filter for different projected trends.

A real time or predicted capacity may be estimated using either a Concentration Front Method or a Loading Front Method. In concentration front method, a Remaining Capacity is calculated as the clean fraction of bed space at the front where one or more concentrations of the target contaminants exceeds the designated exposure limit. In the Loading Front Method, the Remaining capacity is calculated as the Clean Fraction of Bed Space (CFBS) at the front where the total loadings of contaminant exceeds a certain criteria. The loading criteria can either be an arbitrarily assigned (e.g., 1% of the maximum loading), or be estimated from the adsorption equilibrium as the loading value in equilibrium with the exposure limit.

The Remaining Capacity is estimated as either the Remaining Capacity Percentage (RCP), or Remaining Capacity Time (RCT), using the following formulae:

$$RCP = CFBS \times 100 \% \qquad Equation 6$$

$$RCT = \frac{C F B S}{C F B S 0} \times {t}_{b} \qquad Equation 7$$

Here CFBS0 is the CFBS value at the beginning of the operation (e.g. after being operated for a few minutes). t_{b} is the estimated total service life time at the feed condition as provided by the vendor.

It should be noted that the Residual Capacity Time is estimated based on the previous use experience and is subject to change if the filter sees significantly different site conditions from the previous or is used differently by users with different flow rate, breathing rate, or blower rate. For these reasons, it is helpful to supplement an estimated remaining capacity with a predicted remaining capacity generated using trend information.

In some embodiments, simulation generator 560 solves a set of control equations numerically with time and space to provide a real-time estimate of concentration profiles along a bed. Remaining filter capacity may then, in some embodiments, be estimated using current bed profiles and the current feed conditions. Additionally, remaining filter capacity may also be estimated for a future time based on projected trends. An end-of-service life warning may be issued when the estimated remaining capacity is below a preset time threshold based on current estimates. For example, the preset threshold may be less than 30 minutes remaining, less than 1 hour remaining, or another suitable threshold. The threshold of time for warning may vary based on the current conditions and/or projected conditions, for example with a wider margin if a current effluent concentration is higher. in order to better ensure that breakthrough does not occur before the filter is replaced.

System 500 may have a communication component 590 which may communicate with other systems in an environment, other PPE, sensors 510, datastore 520, simulator 560, or other relevant devices or information stores. Communication component 590 may be responsible for generating an alert, using an alert generator 592. if either a real-time estimated capacity or a predicted estimated capacity indicates that a service life is nearing its end. The alert may be sent directly to a PPE device, in some embodiments.

A PPE device may have an indicator that can provide some alert information. The alert may be a light that turns on, off or a different color based on the amount of service life. The alert may also be an audible alert provided through a speaker. The alert could also be haptic feedback.

Communication component 590 may also generate a graphical user interface, using graphical user interface generator 594, which may include an indication of the estimated remaining capacity. the predicted remaining capacity, or both. In some embodiments, only the more conservative estimate is provided.

Simulation generator 560 may generate a new predicted capacity estimator multiple times in a shift. A new simulation may be generated by actuator 576, which may initiate retrieval and simulation based on a number of triggers. In some embodiments, actuator causes retrieval and simulation continuously, or substantially continuously such that a new simulation round is initiated after the previous one ends, with little or no dwell time in between the end of one simulation and the start of the next simulation. Actuator 576 may also cause retrieval and simulation periodically, in some embodiments, with a set or variable dwell time between simulations. Actuator 576 may also, or instead, cause retrieval and simulation based on a detected trigger, such as movement of worker from a first point to a second point, detected change in one or more parameters greater than a threshold change, or another trigger. Actuator 576 may also cause retrieval and simulation based on received input, for example using a user input/output mechanism on a PPE device, based on a command from a supervisor device, or another command received using communication component 590. Communication component 590 may operate using wired or wireless protocols.

Communication component may cause actuator 576 to initiate a simulation when a trigger is received by trigger receiver 596. Communication component may also receive or send other communications 598, using wired or wireless protocols.

System 500 may include a feedback loop, which may be useful where noisy, inaccurate or insufficient data is provided. Filter use simulator may also include an environmental monitor and contaminant detector or analyzer, which may be used to improve future simulation accuracy. For example, a premature, or late, breakthrough may indicate that sensor readings were inaccurate, default readings are too high or too low, or that the concentration of the contaminant was inaccurate. This may provide information for EHS personnel to update default values or check to ensure that sensors are working accurately.

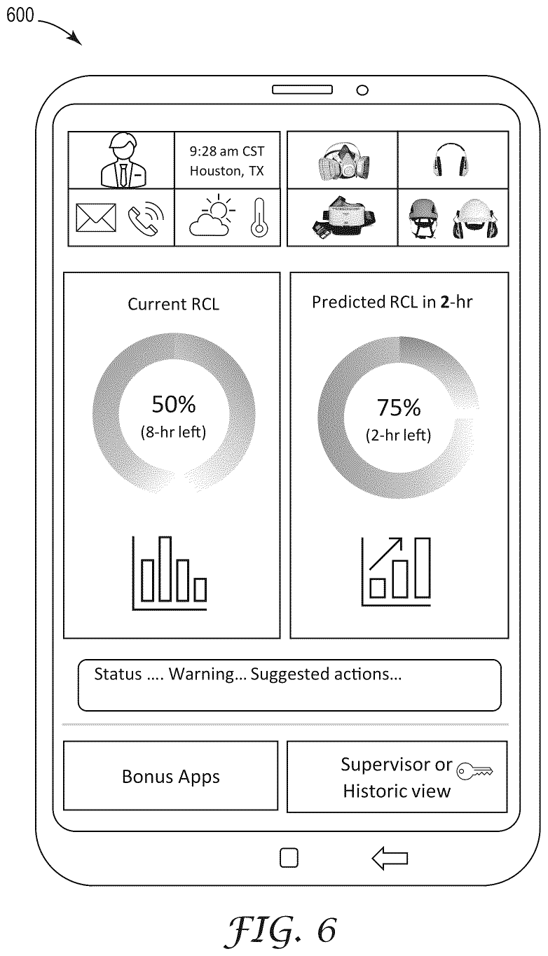

FIG. 6 illustrates a mobile simulation device in one embodiment of the present invention. FIG. 6 illustrates a mobile simulation computing device 600 that may simulate concentration profiles for a filter bed. In some embodiments, device 600 is coupled to a device with a display to provide a visual representation of a current concentration profile. In addition, it could inform the user if a rapid change occur to ones environment, remaining service life, and other items that would tell the user when it necessary to change one's filter. As illustrated in FIG. 6, device 600 includes a connection which may allow for wired communication between device 600 and a datastore with parameter value information. However, it is expressly contemplated that, in other embodiments, wireless communication is possible.

As illustrated in FIG. 6, a current Remaining Capacity Life and a Predicted Capacity Life are displayed. “Current RCL” is calculated and displayed based on current parameter values. The “Predicted RCL” is calculated based on predicted parameter values in the next two hours. Status information, warnings, and suggested actions for a wearer of the RPD may also be presented.

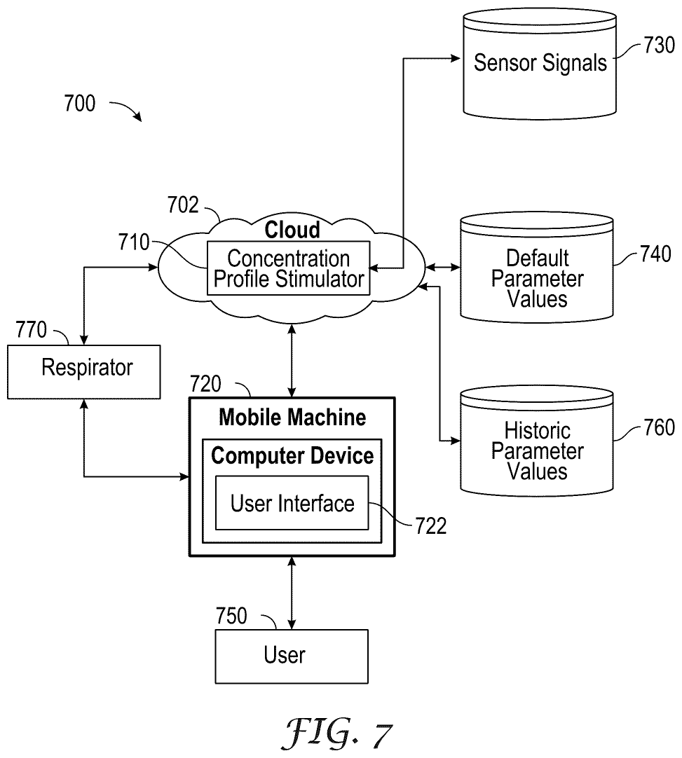

FIG. 7 illustrates a predicted capacity estimation system architecture. Architecture 700 illustrates one embodiment of an implementation of filter loading simulation system 710. As an example, architecture 700 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-6 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 7, some items are similar to those shown in earlier figures. FIG. 7 specifically shows that a system 710 can be located at a remote server location 702. Therefore, computing device 720 accesses those systems through remote server location 702. User 750 can use computing device 720 to access user interfaces 722 as well. For example, a user 750 may be a user wanting to check a fit of their respiratory protection device while sitting in a parking lot, and interacting with an application on the user interface 722 of their smartphone 720, or laptop 720, or other computing device 720.

FIG. 7 shows that it is also contemplated that some elements of systems described herein are disposed at remote server location 702 while others are not. By way of example, data stores 730, 740 and/or 760 can be disposed at a location separate from location 702 and accessed through the remote server at location 702. Regardless of where they are located, they can be accessed directly by computing device 720, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. This may allow a user 750 to interact with system 710 through their computing device 720, to initiate a seal check process.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

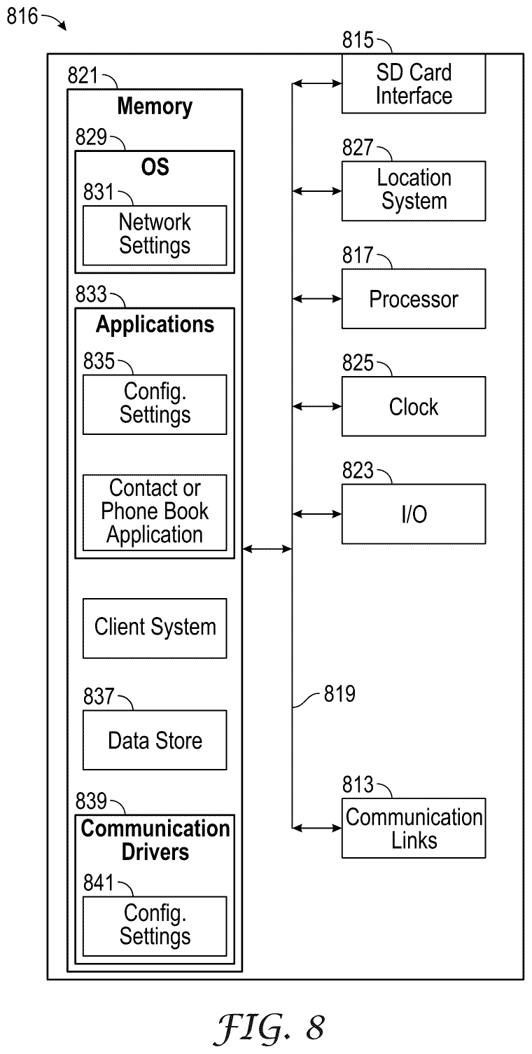

FIGS. 8-10 illustrate example devices that can be used in the embodiments shown in previous Figures. FIG. 8 illustrates an example mobile device that can be used in the embodiments shown in previous Figures. FIG. 8 is a simplified block diagram of one illustrative example of a handheld or mobile computing device that can be used as either a worker's device or a supervisor/safety officer device, for example, in which the present system (or parts of it) can be deployed. For instance, a mobile device can be deployed in the operator compartment of computing device for use in generating, processing, or displaying the data and alerting the user.

FIG. 8 provides a general block diagram of the components of a mobile cellular device 816 that can run some components shown and described herein. Mobile cellular device 816 interacts with them or runs some and interacts with some. In the device 816, a communications link 813 is provided that allows the handheld device to communicate with other computing devices and under some embodiments provides a channel for receiving information automatically, such as by scanning. Examples of communications link 813 include allowing communication though one or more communication protocols, such as wireless services used to provide cellular access to a network, as well as protocols that provide local wireless connections to networks.

In other examples, applications can be received on a removable Secure Digital (SD) card that is connected to an interface 815. Interface 815 and communication links 813 communicate with a processor 817 (which can also embody a processor) along a bus 819 that is also connected to memory 821 and input/output (I/O) components 823, as well as clock 825 and location system 827.

I/O components 823, in one embodiment, are provided to facilitate input and output operations and the device 816 can include input components such as buttons, touch sensors, optical sensors, microphones, touch screens, proximity sensors, accelerometers, orientation sensors and output components such as a display device, a speaker, and or a printer port. Other I/O components 823 can be used as well.

Clock 825 illustratively comprises a real time clock component that outputs a time and date. It can also provide timing functions for processor 817.

Illustratively, location system 827 includes a component that outputs a current geographical location of device 816. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 821 stores operating system 829, network settings 831, applications 833, application configuration settings 835, data store 837, communication drivers 839, and communication configuration settings 841. Memory 821 can include all types of tangible volatile and non-volatile computer-readable memory devices. It can also include computer storage media (described below). Memory 821 stores computer readable instructions that, when executed by processor 817, cause the processor to perform computer-implemented steps or functions according to the instructions. Processor 817 can be activated by other components to facilitate their functionality as well. It is expressly contemplated that, while a physical memory store 821 is illustrated as part of a device, that cloud computing options, where some data and/or processing is done using a remote service, are available.

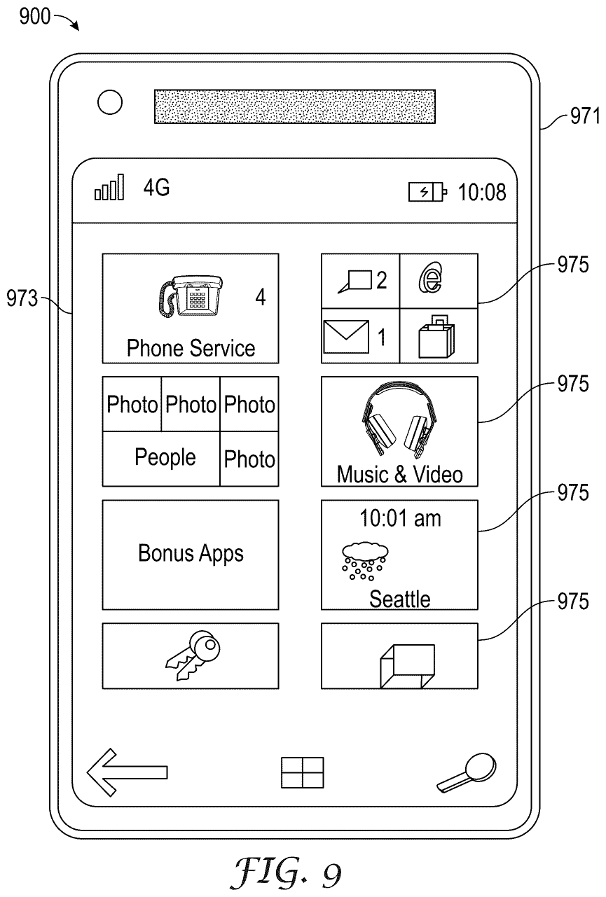

FIG. 9 shows that the device can also be a smart phone 971. Smart phone 971 has a touch sensitive display 973 that displays icons or tiles or other user input mechanisms 975. Mechanisms 975 can be used by a user to run applications, make calls, perform data transfer operations, etc. In general, smart phone 971 is built on a mobile operating system and offers more advanced computing capability and connectivity than a feature phone. Note that other forms of the devices are possible.

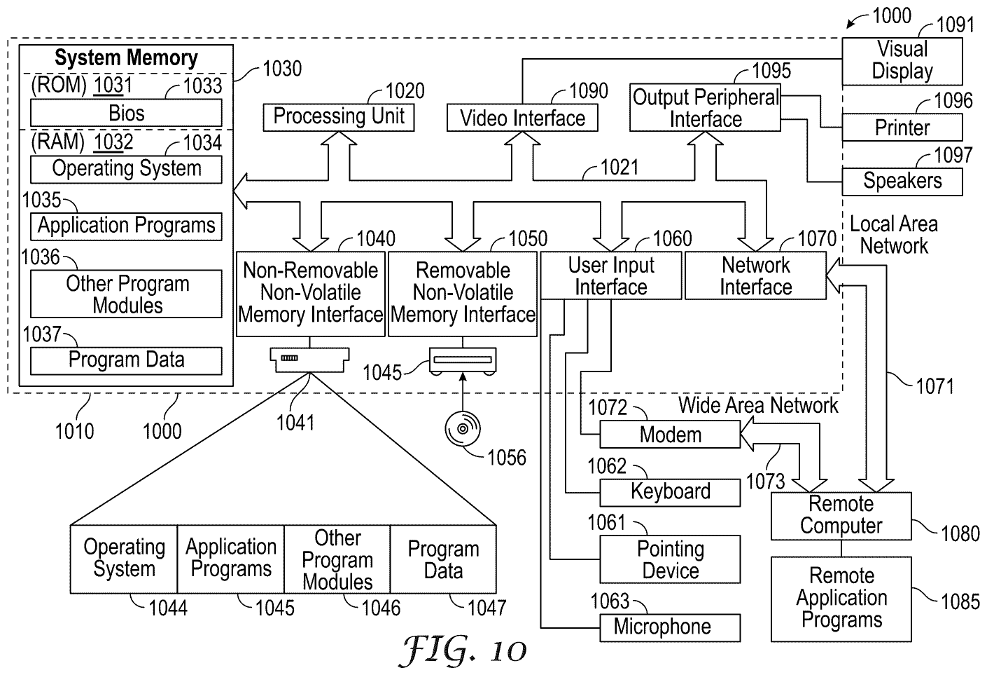

FIG. 10 is one example of a computing environment in which elements of systems and methods described herein, or parts of them (for example), can be deployed. With reference to FIG. 10, an example system for implementing some embodiments includes a general-purpose computing device in the form of a computer 1010. Components of computer 1010 may include, but are not limited to, a processing unit 1020 (which can comprise a processor), a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. Memory and programs described with respect to systems and methods described herein can be deployed in corresponding portions of FIG. 10.

Computer 1010 typically includes a variety of computer readable media. Computer readable media can be any available media that can be accessed by computer 1010 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media may embody computer readable instructions, data structures. program modules or other data in a transport mechanism and includes any information delivery media. The term “modulated data signal” means a signal that has one or more of its characteristics set or changed in such a manner as to encode information in the signal.

The system memory 1030 includes computer storage media in the form of volatile and/or nonvolatile memory such as read only memory (ROM) 1031 and random-access memory (RAM) 1032. A basic input/output system 1033 (BIOS) containing the basic routines that help to transfer information between elements within computer 1010. such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable and volatile/nonvolatile computer storage media. By way of example only, FIG. 10 illustrates a hard disk drive 1041 that reads from or writes to non-removable, nonvolatile magnetic media, nonvolatile magnetic disk 1052, an optical disk drive 1055, and nonvolatile optical disk 1056. The hard disk drive 1041 is typically connected to the system bus 1021 through a non-removable memory interface such as interface 1040, and optical disk drive 1055 are typically connected to the system bus 1021 by a removable memory interface, such as interface 1050.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs). Application-specific Standard Products (e.g., ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037.

A user may enter commands and information into the computer 1010 through input devices such as a keyboard 1062, a microphone 1063, and a pointing device 1061, such as a mouse, trackball or touch pad. Other input devices (not shown) may include a joystick, game pad, satellite receiver, scanner, or the like. These and other input devices are often connected to the processing unit 1020 through a user input interface 1060 that is coupled to the system bus but may be connected by other interface and bus structures. A visual display 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 is operated in a networked environment using logical connections, such as a Local Area Network (LAN) or Wide Area Network (WAN) to one or more remote computers, such as a remote computer 1080.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. In a networked environment, program modules may be stored in a remote memory storage device. FIG. 10 illustrates, for example, that remote application programs 1085 can reside on remote computer 1080.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

The ability of learning from previous application and usage conditions and estimating the remaining capacity life (RCL) or RSL/ESL ahead of time can be critical to some applications and may also help IH and users in routine work and preparations in other applications. This invention fills the gap. This RCL or RSL/ESL program differentiates from other programs in the market.

A predicted remaining filter capacity estimation system that includes a parameter retriever that retrieves parameter information for an atmosphere around the filter, a parameter trend retriever that retrieves historical parameter indications from a database, and a real time capacity estimator that, based on the parameter information retrieved, solves a set of controlling equations to generate an estimated capacity. The controlling equations are a set of mass and energy balance equations. The system also includes a parameter projection generator that, based on the historic parameter indications, generates a future parameter trend for the atmosphere and filter use. The system also includes a predicted capacity estimator that, based on the adsorption estimate, and based on the future parameter trend, generates a predicted capacity estimate. The system also includes a signal generator that generates a signal if either the estimated capacity or the predicted capacity estimate is above a threshold.

The system may be implemented such that the parameter information includes a first concentration value for a first contaminant and a second concentration value for a second contaminant.

The system of may be implemented such that the parameter trend retriever retrieves future parameter estimations from a weather report.

The system may be implemented such that the parameter trend retriever retrieves future parameter estimations from a second device.

The system may be implemented such that the future parameter estimations are based on a set of historic parameter values for the atmosphere.

The system may be implemented such that based on the set of historic parameter values, a maximum parameter value or a minimum parameter value is set for a future parameter trend.

The system may be implemented such that the future parameter estimations are modified by the future parameter indications.

The system may be implemented such that the future parameter indications include a lower than expected temperature, and the future parameter estimation of a temperature is reduced according to the lower than expected temperature.

The system may be implemented such that the future parameter indications include a lower concentration value, and the future parameter estimation of a concentration is reduced according to the lower concentration value.

The system may be implemented such that the future parameter indications include a higher than expected temperature, and the future parameter estimation of a temperature is reduced according to the higher than expected temperature.

The system may be implemented such that the future parameter indications include a higher concentration value, and the future parameter estimation of a concentration is reduced according to the higher concentration value.

The system may be implemented such that the future parameter indication includes a rapid temperature decrease. A slope of a future temperature estimation is adjusted accordingly.

The system may be implemented such that the future parameter indication includes a first concentration value, of a first contaminant, and a second concentration value, of a second contaminant, a second contaminant. The concentration estimation is adjusted accordingly. The system may be implemented such that the future parameter trend is a combination of trends for each of hazard contaminants, atmosphere conditions, and user breathing rate or filter flow rate.

The system may be implemented such that the trend for contaminant concentration or atmosphere condition or breathing rate or flow rate is a linear function, or exponential function, or repeated step function, or sinusoidal function, or oscillatory, or spike function, or combination of any.

The system may be implemented such that the adsorption estimate generator solves the set of controlling equations in substantially real time.

The system may be implemented such that the controlling equations are partial differential equations.

The system may be implemented such that the controlling equations are differential equations.

The system may be implemented such that it includes a controller that initiates retrieval of parameter information by the parameter retriever and generation of the adsorption estimate.

The system may be implemented such that the controller automatically initiates generation, by the adsorption estimate generator, when a detected change in parameter information retrieved is higher than a threshold.

The system may be implemented such that the controller initiates retrieval periodically.

The system may be implemented such that the controller initiates retrieval once per minute.

The system may be implemented such that the controller initiates retrieval based on a user-specified time period, a manufacturer-set time period, or a worksite-wide time period.

The system may be implemented such that the retrieved parameter information is a first retrieved parameter information. The controller causes the parameter retriever to retrieve a second parameter information substantially immediately after the adsorption estimate is generated.

The system may be implemented such that the controller initiates retrieval in response to a user input.

The system may be implemented such that the controller automatically initiates retrieval in response to a trigger.

The system may be implemented such that the triggers is a detected location.

The system may be implemented such that the system is incorporated into a personal protective equipment device.

The system may be implemented such that the personal protective equipment device includes the filter.

The system may be implemented such that the system is remote from a personal protective equipment device including the filter.

The system may also include a network and a communication component that communicates over the network using a network protocol.

The system may be implemented such that the parameter retriever retrieves the parameter information over the network.

The system may be implemented such that the communication component communicates with a database over the network, The generated adsorption estimate is stored in the database.

The system may be implemented such that parameter retriever retrieves the parameter information from the database.

The system may be implemented such that the database includes filter specifications. The retrieved parameter information includes the filter specifications.

The system may also include a controller that automatically initiates retrieval of parameter information and adsorption generation, when a Powered Air Purifying Respirator (PAPR) filter is connected and a flow rate is detected.

The system may be implemented such that the signal is an alert that remaining adsorption capacity estimate is above a threshold.

The system may be implemented such that the retrieved parameter is a contaminant identity. The system may be implemented such that the contaminant identity is retrieved from a contaminant sensor.

The system may be implemented such that the contaminant identity is retrieved from a datastore.

The system may be implemented such that the contaminant identity is manually input.

A method of predicting a remaining capacity estimate for a filter is presented. The method includes retrieving a specification for a filter and a use condition for a device including the filter retrieving a set of environmental parameters for a site. The method also includes retrieving a set of expected parameter values for the site. The method also includes initiating a predicted capacity estimator to, based on the device specification, the use condition, the set of site parameters and the set of expected parameter values, predict a filter capacity by solving a set of controlling equations. The method also includes providing the predicted filter capacity to a receiver.

The method may be implemented such that the set of expected parameter values are based on a weather forecast for the site.

The method may be implemented such that the set of expected parameter values are based on a process schedule for the site.

The method may be implemented such that the set of expected parameter values are based on a user associated with the filter.

The method may be implemented such that the set of expected parameter values include expected vital signs of the user.

The method may be implemented such that the set of expected parameter values include expected location of the user.

The method may be implemented such that retrieving a set of expected parameters includes communicating with a source of the set of expected parameters.

The method may be implemented such that communicating with the source includes wireless communication over a network.

The method may be implemented such that communicating includes accessing a database.

The method may be implemented such that the database is housed within a device that houses the remaining capacity estimator.

The method may be implemented such that the database is housed within a device remote from the remaining capacity estimator.

The method may be implemented such that the controlling equations include a mass balance and an energy balance equation derived to model a mass transfer effect through a sorbent bed.

The method may be implemented such that the controlling equations include partial differential equations.

The method may be implemented such that the controlling equations include differential equations.

The method may be implemented such that the specifications for the device include filter specifications for a filter within the device.

The method may be implemented such that the environmental parameters include a temperature, a relative humidity, a pressure, a contaminant, or a contaminant concentration for the site.

The method may be implemented such that the device specifications include adsorption specifications for the filter.

The method may be implemented such that retrieving environmental parameters is initiated by a trigger.

The method may be implemented such that the steps of initiating and providing proceed automatically if the retrieved set of environmental parameters differ from a stored set of environmental parameters by more than a threshold.

The method may be implemented such that retrieving includes retrieving from a datastore and the device includes the remaining capacity estimator and the datastore.

The method may be implemented such that retrieving includes retrieving from a datastore remote from the device.

The method may be implemented such that providing the remaining capacity includes providing an alert if the remaining capacity is below a threshold.

The method may be implemented such that it also includes retrieving a device use condition. The estimated remaining capacity is based on the device use condition.

A filter capacity prediction estimation device is presented that includes a processing unit configured to, upon receipt of an estimate initiation signal: retrieve a set of default estimate parameters for a filter, retrieve a future parameter value indication for the filter, update the set of default estimate parameters, and generate an estimate for a predicted filter capacity by solving a set of control equations including the updated set of default estimate parameters. The device also includes a feedback generator that generates a feedback signal indicative of the predicted filter capacity.

The device may be implemented such that the future parameter value indication is a trend for a parameter.

The device may be implemented such that the trend includes a rate of change of the parameter. The device may be implemented such that the trend is based on historic values of the parameter.

The device may be implemented such that the trend is based on a forecast value of the parameter.

The device may be implemented such that the forecast value is based on a weather forecast.

The device may be implemented such that the forecast value is based on a work assignment of a user associated with the filter.

The device may be implemented such that the work assignment includes a location for the user.

The device may be implemented such that the forecast value is based on a scheduled process in a site associated with the filter.

The device may be implemented such that the scheduled process includes an increase in concentration from a default concentration.

The device may be implemented such that retrieving a future parameter value indication includes retrieving the trend and a trend modifier, and applying the trend modifier to the trend.

The device may be implemented such that the trend modifier is a maximum value of the parameter or a minimum value of the parameter.

The device may be implemented such that the trend modifier is a multiplier of a rate of change for the parameter.

The device may be implemented such that the trend modifier is retrieved based on a site indication.

The device may be implemented such that the site indication is a new scheduled process or a removal of scheduled process.

The device may be implemented such that the trend modifier is based on a detected vital sign of a user associated with the filter.

The device may be implemented such that the processor retrieves a first future parameter value and a second future parameter value. The first future parameter value includes a future first contaminant concentration. The second future parameter value includes a future second contaminant concentration.

The device may be implemented such that the future first contaminant concentration is for a first contaminant, the future second contaminant concentration is for a second contaminant, and the first contaminant and the second contaminant are different.

A predictive filter capacity simulation system is presented that includes a simulation initiator that receives a simulation command from a requesting device, a parameter retriever that retrieves a filter specification for a filter and an atmosphere specification for a site, a future indication retriever that retrieves a future indication for the filter, the atmosphere, or a site condition in the site, and a predicted capacity estimate generator that, based on the filter specification, the atmosphere specification, and the future indication, generates a remaining capacity estimate for the filter by solving a set of controlling equations, and a communication component that communicates the predicted capacity estimate to the requesting device.

They system may be implemented such that the future indication is a parameter trend for a parameter. The parameter includes a temperature, a relative humidity, a concentration, a worker activity level or a worker assignment.

The system may be implemented such that the parameter trend is based on historical values of the parameter.

The system may be implemented such that the parameter trend is based on a projected parameter value.

The system may be implemented such that the projected parameter value is based on a weather forecast.

The system may be implemented such that the projected parameter value is based on a site operation scheduled for the site.

The system may be implemented such that the parameter trend is modified by a trend modifier.

The system may be implemented such that the trend modifier is a maximum parameter value or a minimum parameter value.

The system may be implemented such that the trend modifier changes a future value of a parameter based on the future indication.

The system may be implemented such that the future indication is a site operation starting or stopping.

The system may be implemented such that the trend modifier changes a rate of change of the parameter trend.

The system may be implemented such that the parameter trend is retrieved from a database based on the future indication.

The system may be implemented such that receipt of the future indication actuates the remaining capacity estimate generator.

The system may be implemented such that the parameter trend is retrieved from a device.

The system may be implemented such that the contaminant concentration is a first contaminant concentration for a first contaminant. A second future indication is retrieved, the second future indication including a second contaminant concentration for a second contaminant.

The system may be implemented such that the second contaminant is different from the first contaminant.

The system may be implemented such that the set of controlling equations includes differential equations.

The system may be implemented such that the set of controlling equations includes partial differential equations.

The system may be implemented such that the atmosphere specification is an estimated parameter value for the site.

The system may be implemented such that the estimated parameter is stored in a datastore.

The system may be implemented such that the estimated parameter is based on historic parameter values.

The system may be implemented such that the estimated parameter is based on a known value.

The system may be implemented such that the known value is a contaminant concentration at a first location, and the estimated parameter is an estimated contaminant concentration at a second location.

The system may be implemented such that the known value is a user gender, height, weight or heart rate and the estimated parameter is an estimated breath rate or flow rate.

A filter capacity monitoring system for a site is presented that includes a respirator with a filter configured to be worn by a user in the site. The system also includes a datastore having site condition information including a concentration of an adsorbable material in the atmosphere of the site, filter specification information, and a parameter trend datastore. The system also includes a forecast generator that retrieves a parameter trend from the parameter trend datastore and applies it to a site parameter to forecast a future value of the site parameter. The system also includes a predictive filter capacity estimator that, based on the future value and the filter specification information, solves a set of controlling equations to generate an predicted capacity estimate indication. The system also includes a communications component that communicates the predicted capacity estimate indication to a receiving device.

The system may be implemented such that the parameter trend is based on a set of historic data of the site parameter.

The system may be implemented such that the set of historic data is a subset selected from a historic dataset.

The system may be implemented such that the site parameter is a temperature and the subset is selected based on a current season.

The system may be implemented such that the site parameter is a temperature and the subset is selected based on current weather conditions.

The system may be implemented such that the parameter trend datastore includes trend modifiers.

The system may be implemented such that the forecast generator selects a trend modifier based on a received indication.

The system may be implemented such that an actuator receives the indication and causes the filter simulation to solve the set of controlling equations in response to the received indication.

The system may be implemented such that the indication is received in substantially real-time.

The system may be implemented such that the indication is a sensor signal indicative of an actual value of the site parameter.

The system may be implemented such that the actuator actuates the filter simulation if the actual value deviates from a previously predicted future value by more than a threshold.

The system may be implemented such that the trend modifier sets a limit on the future value.

The system may be implemented such that the trend modifier adjusts a rate of change of the parameter trend.

The system may be implemented such that the datastore is remote from the respirator.

The system may be implemented such that the site condition information includes a sensor signal retrieved from a sensor in the site.

The system may be implemented such that the site condition information also includes an atmosphere condition retrieved from a weather forecast.

The system may be implemented such that the datastore also includes a default set of atmosphere conditions for the site for use by the filter use simulator in the absence of sensed real-time atmospheric conditions.

The system may be implemented such that it includes a parameter retriever that retrieves sensed real-time atmospheric conditions.

The system may be implemented such that the retrieved sensed real-time atmospheric conditions are retrieved from a site sensor over a site network.

The system may be implemented such that the filter use simulator estimates an atmosphere condition based sensed real-time atmospheric conditions retrieved from a site sensor over a site network.

The system may be implemented such that the estimated atmospheric condition is based on a respirator location signal and a sensor location signal.

The system may be implemented such that the sensed real-time atmospheric condition is based on a weather forecast for the site.

The system may be implemented such that the receiving device is the respirator.

### EXAMPLES

### Example 1

### Forward Prediction of Remaining Capacity Life (RCL)

Petrochemical plants store large quantities of chemicals with the potential for leakage of dangerous materials. The work-sites may have low exposure level levels to hazardous chemical materials during regular operations due to outdoor operations and safety controls in place. However, during periodical maintenance work when the plant operations are stopped and processing facilities or equipment are opened for activities such as draining, cleaning, sampling, repairing, and replacing, the exposure to higher concentrations of hazardous chemicals maybe higher. For example, workers in large-scale petrochemical complexes may have risk of direct exposure to benzene and other hydrocarbon vapors. Depending on the actual maintenance activity, the benzene and other hazards exposure may be different from one process to another and from one time to the next.

For a given user starting in a maintenance activity, a respirator, set of filters, environmental conditions, concentrations environment, and use parameters are populated into the simulation software. From this information remaining capacity life at that time are estimated. The software can store the parameters and RCL as generated and build their trends or modify historical trends if available. The built or modified trends can be analyzed and updated with statistics like averages, maximum, minimum, time-based variations, etc.

With the modified trends, the software can predict what each parameter may be in 2 hours for example. Then the predicted parameters in 2 hours are used as inputs in predicting what benzene RCL may be in 2 hours.

Additionally, the current and predicted benzene exposure are compared to the regulation exposure limits and the trend to make sure they are not exceeding limits or outside of trends with pre-determined criteria. Other information such as user breathing rate, relative humidity and temperature are compared as well. The alarm may be triggered with optional actions in the case of, for examples, higher-than-maximum exposure, or extremely high user breathing rate, or faster benzene increase rate either currently or predictively. Similarly, the current and predicted RCL can be made and compared to its trend as well. In the case of any out of the trend, the alarm may be triggered, and suggestive actions may be provided. The worker now can visualize the predicted parameters and RCT based on the trends built.

For the trends to be modified over time as real time parameters of environment and use conditions become available, the user may enter a pre-determined occurrence time such as every 10 seconds or 2 minutes to take in new measurements for such trend modifications; depending on need of information

The user may also enter an advanced time, such as 2 hours or 8 hours ahead of current time, for forward ESL predictions.

The predicted trends and forward prediction of remaining capacity can alert the workers ahead of time before any significant event such as exceeding the regulation limits or end of respirator filter may occur.

### Example 2

### Forward Prediction for User Under Significantly Different Conditions

In shipbuilding industry, the surface coating preparation and painting for all tank and compartment surfaces use predominantly solvent-based coatings. Relatively large amounts of organic solvents are used in cleaning and thinning activities. Acetone and MEK (methyl ethyl ketone), for example, are two commonly used solvents with high evaporative rates for such cleaning and thinning operations. Additionally, reactions between the cleaning solvents and the material being removed may also produce additional toxic vapors. All those present a significant respiratory risk for the workers.

Often the work is done in enclosed or confined spaces on a ship. Each of the enclosed space may present significantly different hazards to workers depending on the type of work and organic vapor being used. In the case one worker may go from one space to another and experience multiple hazardous conditions, the simulation software can track parameters and RCL for each hazardous chemical and build RCLs based on the order and time the worker enters each space. For example, the simulation software may take in respirator/filter, concentrations, environmental conditions, environment, and use parameters to estimate current RCL and build trends to estimate predicted RCL for chemicals in the 1^{st} space. Then the tracked RCLs are used as the basis when worker enters the next space. With the parameters of the 2^{nd} space populated in the simulation software, it may generate the new parameter trends specific to the 2^{nd} space and use those trends to estimate current and predicted RCLs of chemicals in this space. And the process continues on. The alarm may be triggered if the predicted RCL for any experienced chemical may reach the lower limit in one hour for example, otherwise, the accumulative RCLs are saved and used for next shift's prediction.

### Example 3

### Forward Prediction With Multiple Users

In semiconductor industry many production jobs involve use of chemicals for cleaning, stripping or degreasing, some of which may expose workers to hazards in enclosed or confined spaces. A large gamete of solvents and acids are common hazardous chemicals in semiconductor production areas.

For manufacturing processes with multiple workers, depending on the process and work, the respirators used may be of different types such as OV (organic vapor) filter, OV/AG (organic vapor and acid gas) respirator, or multigas filter. Each of them may be equipped with the simulation software that is connected to a central station. The parameters of respirator, environment and use conditions, along with estimated and predicted RCLs from each respirator, as they are generated, may be continuously communicated to the central station and saved to a database. In the case of any significant event such as RCL nearing the limit, or high breathing rate, or unusually high chemical concentration for any worker, the central station may communicate back to the individual and/or notify the area and lead person as well.

### Example 4

### Lead User

In work areas where there is a large number of workers, it is useful to focus the model on a single user or a handful of users considered “lead” users. A lead user according to this example is a worker who represents a worst case for estimating RCL for example due to his higher breathing rate. The model described in this invention utilizes data from the lead user to make prediction of RCL for the entire group of workers. It is also contemplated that the lead user is a model worker where the calculated RCL for his respirator filter provides accurate RCL information for the entire work group in the designated work area. The advantage of designating a lead user is to minimize the number of calculations carried out by the model decreasing the response time and reducing power consumption.

### Example 5

### Drone

One method to improve the accuracy of the simulation is to use a drone before and during operation. The drone (UAV) operating in the work area can be equipped with a gas sensor can continuously map in real time the concentration of hazardous gas and vapor in the work area and input the data into the predictive model in this invention to calculate in real time the remaining service life (RCL) of the filter on the respirator used by workers in the work area. The UAV can detect leaks in high pressure gas tanks and transmit information about such leaks to the model, which can predict increase in the gas concentration resulting in reduction in the RCL of filters used by workers.

What is claimed is:

1. A predicted remaining filter capacity estimation system comprising:
a parameter retriever that retrieves parameter information for an atmosphere around the filter;
a parameter trend retriever that retrieves historical parameter indications from a database;
a real time capacity estimator that, based on the parameter information retrieved, solves a set of controlling equations to generate an estimated capacity, wherein the controlling equations are a set of mass and energy balance equations;
a parameter projection generator that, based on the historic parameter indications, generates a future parameter trend for the atmosphere and filter use;
a predicted capacity estimator that, based on the adsorption estimate, and based on the future parameter trend, generates a predicted capacity estimate; and
a signal generator that generates a signal if either the estimated capacity or the predicted capacity estimate is above a threshold.

2. The system of claim 1, wherein the parameter information comprises a first concentration value for a first contaminant and a second concentration value for a second contaminant.

3. The system of claim 1, wherein the parameter trend retriever retrieves future parameter estimations from a weather report.

4. The system of 1, wherein the future parameter estimations are based on a set of historic parameter values for the atmosphere.

5. The system of claim 4, wherein the future parameter estimations are modified by the future parameter indications.

6. The system of claim 5, wherein the future parameter indication comprises a first concentration value, of a first contaminant, and a second concentration value, of a second contaminant. a second contaminant, and wherein the concentration estimation is adjusted accordingly.

7. The system of claim 1, wherein the adsorption estimate generator solves the set of controlling equations in substantially real time.

8. The system of claim 7, wherein the controlling equations are partial differential equations.

9. The system of claim 1, and further comprising:
a controller that initiates retrieval of parameter information by the parameter retriever and
generation of the adsorption estimate.

10. A method of predicting a remaining capacity estimate for a filter, the method providing:
retrieving a specification for a filter and a use condition for a device comprising the filter;
retrieving a set of environmental parameters for a site;
retrieving a set of expected parameter values for the site;
initiating a predicted capacity estimator to, based on the device specification, the use condition, the set of site parameters and the set of expected parameter values, predict a filter capacity by solving a set of controlling equations; and
providing the predicted filter capacity to a receiver.

11. The method of claim 10, wherein the set of expected parameter values are based on a process schedule for the site.

12. The method of claim 10, wherein the set of expected parameter values are based on a user associated with the filter.

13. The method of claim 12, wherein the set of expected parameter values comprise expected location of the user.

14. The method of claim 10, wherein the controlling equations comprise a mass balance and an energy balance equation derived to model a mass transfer effect through a sorbent bed.

15. The method of claim 10 wherein the specifications for the device comprise filter specifications for a filter within the device.

16. The method of claim 10, wherein the environmental parameters comprise a temperature, a relative humidity, a pressure, a contaminant, or a contaminant concentration for the site.

17. The method of claim 10, wherein the steps of initiating and providing proceed automatically if the retrieved set of environmental parameters differ from a stored set of environmental parameters by more than a threshold.

18. The method of claim 10, and also comprising:
retrieving a device use condition; and
wherein the estimated remaining capacity is based on the device use condition.

19. A filter capacity prediction estimation device comprising:
a processing unit configured to, upon receipt of an estimate initiation signal:
retrieve a set of default estimate parameters for a filter;
retrieve a future parameter value indication for the filter;
update the set of default estimate parameters; and
generate an estimate for a predicted filter capacity by solving a set of control equations comprising the updated set of default estimate parameters; and
a feedback generator that generates a feedback signal indicative of the predicted filter capacity.

20. The device of claim 19, wherein the future parameter value indication is a trend for a parameter.
